(19) United States
(12) Patent Application Publication
(10) Pub. No.: US 2026/0121934 A1
(43) Pub. Date: Apr. 30, 2026

(54) TOPOLOGY MANAGEMENT FOR TIME SENSITIVE NETWORKING

(71) Applicant: Schneider Electric USA, Inc., Andover, MA (US)

(72) Inventor: Alen Mehmedagic, Wilmington, MA (US)

(73) Assignee: Schneider Electric USA, Inc., Andover, MA (US)

(21) Appl. No.: 19/003,894

(22) Filed: Dec. 27, 2024

Related U.S. Application Data
(60) Provisional application No. 63/616,504, filed on Dec. 29, 2023.
(60) Provisional application No. 63/739,094, filed on Dec. 26, 2024.

(51) Int. Cl. H04L 41/12; H04L 41/22; H04L 43/08

(52) U.S. Cl. CPC H04L 41/12; H04L 41/22; H04L 43/08

(57) ABSTRACT

Systems/methods for setting up, maintaining, and managing network topologies provide a network topology manager. The network topology manager incorporates existing standardized concepts as described in OPCUA and IEC/IEEE 6082, and adds an additional dimension of time. This allows users to construct TSN-based networks from a system level view based on a network-oriented perspective, as opposed to a device-oriented perspective, and automatically determines whether TSN timing requirements are satisfied. The network topology manager provides the foregoing features and other features through a graphical interface that allows users to quickly set up and configure a TSN-based network. Such a network topology manager advantageously extends beyond the capability of currently available network topology manager viewers and applications to encompass the OPCUA/TSN domain.

### CROSS-REFERENCE TO RELATED APPLICATIONS

This application for patent claims the benefit of priority to and incorporates herein by reference U.S. Provisional Application No. 63/616,504, entitled “Topology Management for Time Sensitive Networking,” filed Dec. 29, 2023, and U.S. Provisional Application No. 63/739,094, entitled “Topology Management for Time Sensitive Networking,” filed Dec. 26, 2024.

### FIELD

The present disclosure relates generally to systems and methods for management of network topologies, and particularly to systems and methods for setting up, maintaining, and managing network topologies that can support Time-Sensitive Networking (TSN).

### BACKGROUND

Time-Sensitive Networking (TSN) refers to a set of industrial networking standards specified by IEEE 802.1. The TSN standards can provide fully deterministic, real-time delivery of network messages over standard Ethernet networks for time-critical network applications. Features of TSN include time synchronization amongst the various networked devices, scheduling and traffic shaping for routing of communication packets, and uniform path selection rules that achieve low transmission latency, high availability, and fault tolerance.

As might be expected, TSN-based network topologies are complex, difficult to configure, and require regular maintenance. However, existing TSN-based network topology managers are limited to visualization of networks from the perspective of field level devices, such as programmable automation controllers (PACs), programmable logic controllers (PLCs), and other similar controllers. The main function of these network topology solutions is to provide a view of the network topology in terms of the physical connectivity of the controllers based on their underlying device protocols, such as RSTP (Rapid Spanning Tree Protocol), Modbus, and the like.

With increasing adoption of TSN as well as OPCUA (Open Platform Communications Unified Architecture) in industrial networks, and particularly the OPCUA FX (Field exchange) framework designed for field level communication in industrial automation, an added dimension is needed for TSN-based network topology managers, namely, a time dimension, in order to effectively manage TSN-based network topologies.

### SUMMARY

Embodiments of the present disclosure relate to systems and methods for setting up, maintaining, and managing network topologies that can support TSN. The systems and methods herein provide an application for managing network topologies, or a network topology manager, that incorporates existing standardized concepts as described in OPCUA and IEC/IEEE 6082, and adds an additional dimension of time. The network topology manager allows users to construct TSN-based networks from a system level view based on a network-oriented perspective, as opposed to a device-oriented perspective, and automatically determines whether TSN timing requirements are satisfied. The network topology manager provides the foregoing features and other features through a graphical interface that allows users to quickly set up and configure a TSN-based network. Such a network topology manager advantageously extends beyond the capability of currently available network topology manager viewers and applications to encompass the OPCUA/TSN domain.

In general, in one aspect, embodiments of the present disclosure relate to a system for managing TSN-based network topologies. The system comprises, among other things, a processor, and a display unit communicatively coupled to the processor and configured be controlled by the processor to display graphical and textual information. The system further comprises a storage unit communicatively coupled to the processor, the storage unit storing processor-executable instructions thereon for a network topology manager. The network topology manager, when executed by the processor, causes the system to display on the display unit a canvas on which network devices and network applications may be graphically placed, and allow a user to graphically create a network topology on the canvas using the network devices and the network applications. The network topology manager additionally causes the system to define one or more streams in the network topology based on the network devices and the network applications, each stream including a talker node and a listener node and one or more message timing requirements for a message from the talker node to the listener node. The network topology manager also causes the system to identify, for at least one stream, a path in the stream that is capable of transmitting a message for the stream, and calculate a path latency for the path, the path latency indicating a time required to transmit a message from the talker node to the listener node along the path. The network topology manager further causes the system to determine whether the path latency for the path fails to satisfy the one or more message timing requirements for the message from the talker node to the listener node, and update the network topology on the canvas to include the path and an indication of whether the path latency for the path fails to satisfy the one or more message timing requirements.

In general, in another aspect, embodiments of the present disclosure relate to a method for managing TSN-based network topologies. The method comprises, among other things, performing, by a processor, a process that displays on a display unit a canvas on which network devices and network applications may be graphically placed, and performing, by the processor, a process that allows a user to graphically create a network topology on the canvas using the network devices and the network applications. The method additionally comprises performing, by the processor, a process that defines one or more streams in the network topology based on the network devices and the network applications, each stream including a talker node and a listener node and one or more message timing requirements for a message from the talker node to the listener node. The method also comprises performing, by the processor, a process that identifies, for at least one stream, a path in the stream that is capable of transmitting a message for the stream, and performing, by the processor, a process that calculates a path latency for the path, the path latency indicating a time required to transmit a message from the talker node to the listener node along the path. The method further comprises performing, by the processor, a process that determines whether the path latency for the path fails to satisfy the one or more message timing requirements for the message from the talker node to the listener node, and performing, by the processor, a process that updates the network topology on the canvas to include the path and an indication of whether the path latency for the path fails to satisfy the one or more message timing requirements.

In accordance with any one or more of the foregoing embodiments, the network topology manager further causes the system to provide at least one library configured to store network the network devices and the network applications therein.

In accordance with any one or more of the foregoing embodiments, the network topology manager further causes the system to identify a redundant path for the at least one stream and to calculate a path latency for the redundant path, and determine a lowest path latency for the at least one stream based on the path latency of the path and the path latency of the redundant path.

In accordance with any one or more of the foregoing embodiments, the network topology manager further causes the system to display the path on the canvas using a preselected color and/or a preselected line type if the path latency for the path fails to satisfy the one or more message timing requirements.

In accordance with any one or more of the foregoing embodiments, the network topology manager further causes the system to display the network topology on the canvas using a communication timing diagram (CTD), the CTD including a latency line for each stream in the network topology, each latency line having one or more blocks thereon, each block being proportional to a size of a message frame transmitted for the stream, and allow the user to graphically adjust a length of the latency line for each stream using a sliding motion, and to graphically adjust a position of the one or more blocks on the latency line using a sliding motion.

In accordance with any one or more of the foregoing embodiments, the network topology manager further causes the system to display the network topology on the canvas using a gate timing view (GTV), the GTV including a time graph for each stream in the network topology, each time graph having one or more blocks thereon, each block being proportional to an amount of time that a given device spends transmitting a message frame for the stream.

In accordance with any one or more of the foregoing embodiments, the network topology manager further causes the system to display the path on the canvas using a preselected color and/or a preselected line type if the path latency for the path fails to satisfy the one or more message timing requirements.

In accordance with any one or more of the foregoing embodiments, the one or more message timing requirement includes a communication interval and at least two streams in the network topology have different communication intervals from one another.

In general, in yet another aspect, embodiments of the present disclosure relate to a non-transitory computer-readable medium storing computer-readable instructions thereon that, when executed by a processor, causes the processor to perform a method in accordance with any one or more of the foregoing embodiments.

### BRIEF DESCRIPTION OF THE DRAWINGS

The foregoing features of the disclosure, as well as the disclosure itself may be more fully understood from the following detailed description of the drawings, in which:

FIG. 1 shows an exemplary system for a network topology manager in accordance with embodiments of the disclosure;

FIG. 2 shows an exemplary control panel for a network topology manager in accordance with embodiments of the disclosure;

FIG. 3 shows exemplary catalog for storing network device objects in a network topology manager in accordance with embodiments of the disclosure;

FIG. 4 shows an exemplary catalog for storing network application objects in a network topology manager in accordance with embodiments of the disclosure;

FIG. 5 shows an exemplary canvas for creating network topologies in a network topology manager in accordance with embodiments of the disclosure;

FIG. 6 shows an exemplary topology created by a network topology manager for a network in accordance with embodiments of the disclosure;

FIG. 7 shows exemplary streams for a network topology in a network topology manager in accordance with embodiments of the disclosure;

FIG. 8 shows an exemplary communication timing diagram for a network topology manager in accordance with embodiments of the disclosure;

FIG. 9 shows exemplary adjustments being made to a communication timing diagram (CTD) in accordance with embodiments of the disclosure;

FIG. 10 shows alternative adjustments being made to a communication timing diagram (CTD) in accordance with embodiments of the disclosure;

FIG. 11 shows an exemplary gate timing view for a network topology manager in accordance with embodiments of the disclosure;

FIG. 12 shows an exemplary overlay view combining a communication timing diagram and a gate timing view in accordance with embodiments of the disclosure;

FIG. 13 shows alternative streams for a network topology in a network topology manager in accordance with embodiments of the disclosure;

FIG. 14 shows exemplary redundant paths in a network topology in accordance with embodiments of the disclosure;

FIG. 15 shows an exemplary one-to-many network topology for a network topology manager in accordance with embodiments of the disclosure;

FIG. 16 shows an exemplary communication timing diagram for a one-to-many network topology in accordance with embodiments of the disclosure;

FIG. 17 shows an exemplary overlay view for a one-to-many network topology in accordance with embodiments of the disclosure;

FIG. 18 shows an exemplary multi-interval network topology in accordance with embodiments of the disclosure;

FIG. 19 shows an exemplary communication timing diagram view for a multi-interval network topology in accordance with embodiments of the disclosure;

FIG. 20 shows an exemplary overlay view for a multi-interval network topology in accordance with embodiments of the disclosure;

FIG. 21 shows exemplary functional block diagram of an exemplary system that may be used to implement various embodiments of this disclosure; and

FIG. 22 shows a functional block diagram of a storage system that may be used to implement various embodiments of this disclosure.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

As mentioned above, TSN provides fully deterministic, real-time delivery of network messages over standard Ethernet networks for time-critical network applications. OPCUA standardizes how devices exchange data by allowing devices from different vendors to modeled using a standard format. The use of OPCUA over TSN-based networks enables high-speed and time-sensitive networking applications that are vendor agnostic, such as the Industrial Internet of Things (IIoT). Embodiments of the present disclosure leverage OPCUA and TSN to provide systems and methods for setting up, maintaining, and managing network topologies in such networking applications. The disclosed systems and methods allow for deployment of communication paths and calculation of timing for such communication paths in an industrial network. Exemplary features of these embodiments include a network topology and timing user interface (UI) that identifies and displays lowest latency paths, unique redundant time bound paths, multi-stream network schedules, and the like. It should be noted that although OPCUA is primarily discussed herein, the disclosed embodiments are equally applicable to other communication protocols, such as NETCONF, within the scope of he present disclosure. For the avoidance of doubt, a network topology as used herein refers to the logical and physical arrangement of network elements, including nodes, devices, links, and the like.

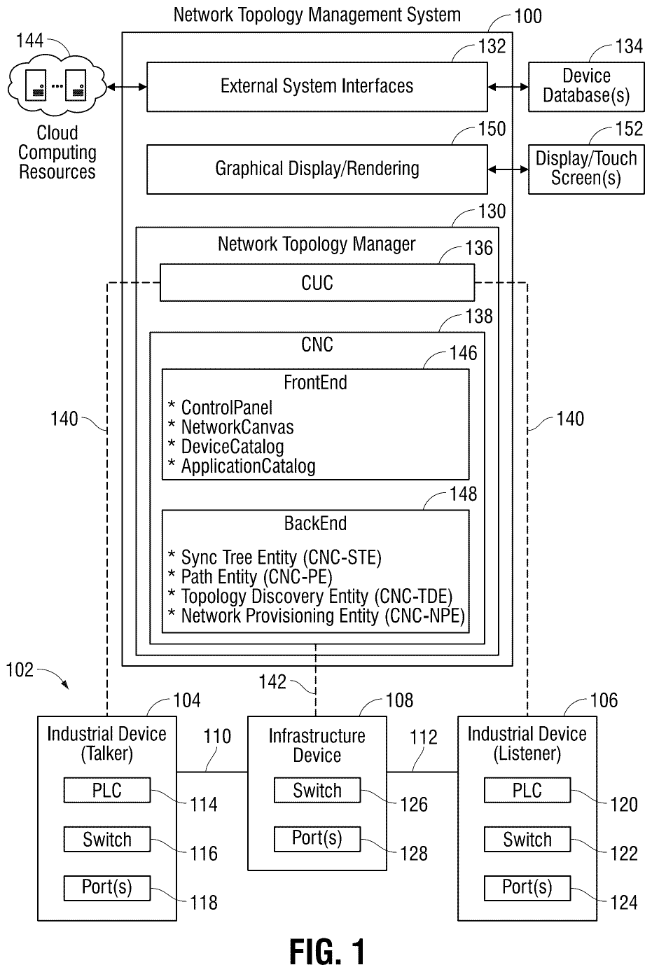

Referring now to FIG. 1, a partial block diagram of a network topology management system 100 (and method therefor) is shown according to embodiment of the present disclosure. In general, the network topology management system 100 operates or may be operated to set up, configure, and control various connections within a network 102 based on any of the network communication protocols mentioned earlier (e.g., OPCUA, NETCONF, etc.). The network 102 may be a TSN-based industrial network that includes a first industrial device 104 configured as a “talker” connected to a second industrial device 106 configured as a “listener” via at least one infrastructure device 108. The roles of “talker” and “listener” may of course be reversed as needed in the network 102. A wired or wireless connection 110 connects the first industrial device 104 to the infrastructure device 108, and a wired or wireless connection 112 connect the infrastructure device 108 to the second industrial device 106. For ease of explanation only, the connections 110, 112 and other network connections herein are assumed to be wired (e.g., Ethernet) connections.

In the FIG. 1 example, the first industrial device 104 is a typical industrial device having one or more components, including a programmable logic controller (PLC) 114, a switch 116, and one or more ports 118. Examples of the industrial device 104 may include sensors, meters, counters, and the like. The second industrial device 106 is likewise a typical industrial device having one or more components, including a programmable logic PLC 120, a switch 122, and one or more ports 124. Examples of the industrial device 106 may include actuators, regulators, controllers, and the like. The at least one infrastructure device 108 is also a typical infrastructure device having one or more components, including a switch 126 and one or more ports 118. Examples of the infrastructure device 108 may include switches, relays, bridges, and the like. Operation of the first and second industrial devices 104, 106 and the infrastructure device 108 is generally well known and therefore a detailed description is omitted here for economy.

The network topology management system 100 may then be used to set up, configure, and control the first and second industrial devices 104, 106 and the at least one infrastructure device 108 to send and receive time-sensitive messages over the network 102. To this end, the network topology management system 100 is provided with a network topology manager 130 and one or more external system interfaces 132. The network topology manager 130 implements various functionality described in IEC/IEEE 60802 to calculate and deploy time-sensitive message schedules for industrial endpoints like the industrial devices 104, 106. The one or more external system interfaces 132, meanwhile, allows the network topology manager 130 to interact with various external systems and databases 134. This allows users (e.g., network administrators), whether local or remote, to set up, configure, and control communication between the industrial devices 104, 106, as well as deploy pre-calculated communication paths that connect the devices 104, 106, over the at least one network infrastructure device 108.

Configuring a TSN-based network such as the network 102 involves the use of a CNC (Centralized Network Controller) to configure the switches in the network to provide a path for messages to be routed through the switches based on the type of devices that send and receive the messages. TSN-based networks also use a CUC (Centralized User Configurator) to provide connection configurations that carry parameters required to provision a TSN stream within the network switches as well as controller and device switches. The CUC is basically a network management entity that is responsible for translation/interpretation of application specific communication requirements into network requirements. The CNC is similarly a network management entity that implements functionality described in IEC/IEEE 60802 and, as such, is capable of calculating and deploying time sensitive schedules on networking devices and industrial end points. In short, the CUC and CNC allow users to easily and effectively construct, deploy and manage their time sensitive OPCUA/TSN based applications and network.

As used herein, the term “application,” when used with reference to a network, refers to an industrial application, such as a cheese slicing application. When “application” is used with reference to a device within the network, the term refers to an application running at the Application layer of the Open Systems Interconnection (OSI) model.

In accordance with embodiments of the present disclosure, the network topology manager 130 is provided with a CUC 136 and a CNC 138, as well as any other logical entities that may be needed. The CUC 136 interacts with the industrial devices 104, 106 via one or more CUC control paths 140 in the network 102 to determine the parameters required by each device for message traffic over the connections 110, 112, and passes those parameters to the CNC 138. The CNC 138 receives the parametric requirements from the CUC 136 and accordingly configures the at least one infrastructure device 108 via one or more CNC control paths 142 in the network 102 to convey the message traffic over the connections 110, 112 in the time required by the devices 104, 106. In some embodiments, the CUC 136 and CNC 138 may be deployed as separate entities, as depicted here, or together as a monolithic application, whether embedded locally in the network topology management system 100, or as a collection of services provided via a cloud computing resource 144, or a combination of both. Note also that the CUC 136 and CNC 138 together operate to provide what is commonly referred to as software defined networking (SDN), leading to intent-based networks.

In some embodiments, the CNC 138 as contemplated herein includes the following known features and capabilities: (i) a Sync Tree Entity (CNC-STE) configured to compute, establish, and maintain time sync trees for working clocks and global time; (ii) a Path Entity (CNC-PE) configured to compute, establish, and maintain message forwarding paths through the network; (iii) a Topology Discovery Entity (CNC-TDE) configured to discover an industrial automation (IA) station, including bridges and end stations, verify that a network topology is engineered (e.g., fixed topology, paths), maintain an inventory of devices, and detect changes in network topology; and (iv) a Network Provisioning Entity (CNC-NPE) configured to apply network policy created by engineering tools (e.g., VLANs, TAS (Time Aware Shaper), etc.).

In addition, the CNC 138 according to embodiments herein is constructed in modular fashion so that its functions may be substituted as needed in a known manner. The embodiments contemplate implementation of and user interaction with the CUC 136 and CNC 138 as software in the network topology manager 130. Deployment of the topology manager 130 can likewise be performed as a monolithic application, a distributed application, or a collection of cloud-based services. For convenience and ease of understanding, embodiments of the network topology manager 130 herein may sometimes be discussed as a logically monolithic software application combining the functionality of the CUC 136 and CNC 138 in an integrated solution.

In some embodiments, the CNC 138 has two major parts, a FrontEnd 146 and a BackEnd 148. The FrontEnd 146 operate as a user interface (UI) for the CNC 138 and provides a distinct user experience (UX). This FrontEnd 146 is responsible for visualization of the network 102 and interactions with users. A graphical display unit 150 in the network topology management system 100 performs graphical rendering of the user interface and visualization provided by the FrontEnd 146 and outputs the rendering to one or more display/touch screens 152. The BackEnd 148 executes and otherwise implements algorithms for discovery of network paths (e.g., connections 110, 112) and their timings among various streams, where each stream represents a message traffic flow (i.e., a flow of message frames through the network). This BackEnd 148 contains constructs of logical (i.e., virtualized) representation of the network, devices, ports, links, and streams. The BackEnd 148 is separated from the FrontEnd 146 in some embodiments so that each entity can be implemented in an embedded CNC application where the topology can be described programmatically.

In some embodiments, the user front end interface (FrontEnd 146) includes the following functional components or elements: a (i) ControlPanel configured for setting and executing various features and functionalities described herein via a plurality of control buttons, checkboxes, configuration fields, and the like; (ii) a NetworkCanvas configured for drawing the network topology; (iii) a DeviceCatalog configured for management of devices; and (iv) an ApplicationCatalog configured for management of applications. The user front end interface (FrontEnd 146) also provide various network views and perspectives based on a given context, including a communication timing diagram (CTD), a gate timing view (GTV), a topological path view (TPV), and the like. These functional components or elements are discussed further below.

The ControlPanel provides a main user interface (UI) that resembles a typical control panel in appearance and from which a user may launch or execute various features and functionalities described herein for the network topology manager 130. To this end, the control panel displays a number of control buttons, checkboxes, configuration fields, and the like, that a user may click, press, touch, check, fill in, or otherwise actuate. The control buttons allow the user to launch one or more features and functionalities of the topology manager 130, the checkboxes allow the user to select one or more settings for the topology manager 130, the configuration fields allow the user to specify one or more parameters for the topology manager 130, and so forth.

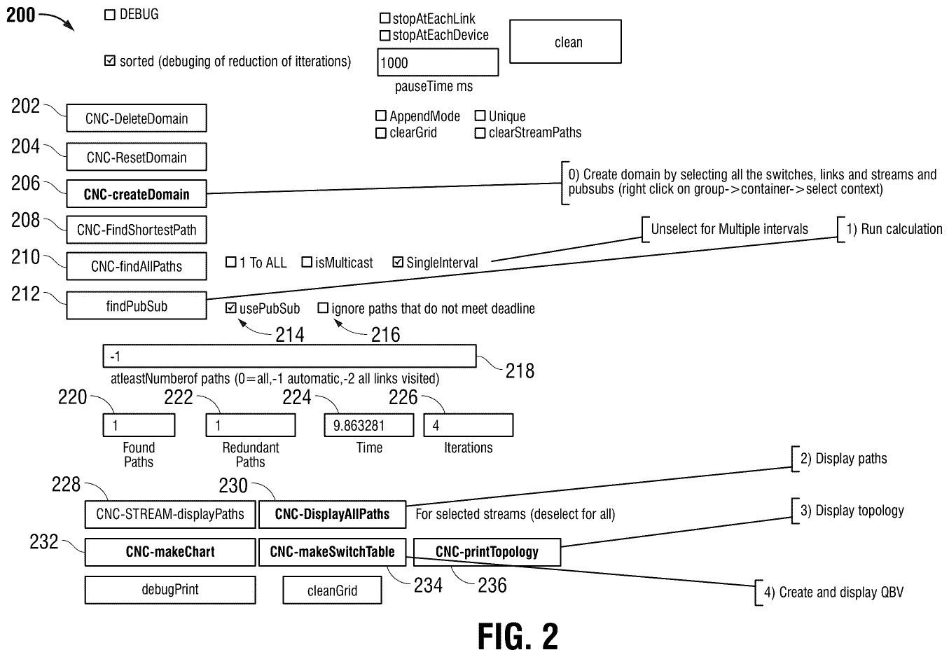

FIG. 2 shows an exemplary control panel 200 for the network topology manager 130 according to some embodiments. As can be seen, the control panel 200 provides a series of controls, configurations, and settings that a user may use to select, specify, and initiate the various features and functionalities of the network topology manager 130. It will be appreciated that the shapes, sizes, appearances, and locations of the controls, configurations, and settings shown are exemplary only, and variations and modifications thereof are within the scope of the present disclosure. In addition, although the controls, configurations, and settings are arranged here in the form of a control panel, it will be appreciated that a different layout may also be used, such as a toolbar, toolbox, tool panel, and the like.

In the control panel 200 of FIG. 2, clicking a button 202 causes the network topology manager 130 to delete an existing network domain (i.e., logical or administrative grouping of network devices) that was previously created and saved by a user. A button 204 causes the topology manager 130 to reset the domain back to a previously saved state, and a button 206 causes it to create a new domain from network devices selected by the user. A button 208 causes the topology manager 130 to find and display the shortest network path (i.e., path with the least required time to traverse) between two end nodes for a selected domain, and a button 210 causes it to calculate and display paths between selected nodes in the domain. The particular paths that the topology manager 130 takes into account depends on the settings that the user entered in field 218, discussed later herein. A button 212 causes the topology manager 130 to calculate and display how much time is required for a message to travel from a talker to a listener over a path in the network, as well as how much time the message is required to spend at each hop in each path. The topology manager 130 may perform the calculations for all available paths in the network or only certain user-specified paths in the network. In this regard, button 212 executes similar functionality as button 210 above, except the data that the topology manager 130 uses for path calculations associated with button 210 comes from the nodes themselves, while the data used for path calculations associated with button 212 comes from the streams drawn by the user. In essence, button 212 is associated an automated version of the path calculation functionality associated with button 210.

In some embodiments, as an option, the control panel 200 also provides a checkbox 214 that the user can select to have the network topology manager 130 use PubSub messaging (i.e., asynchronous messaging) when calculating and displaying paths, and a checkbox 216 to have it not display any paths that fail to meet user-specified message timing requirements. In regard to box 210 discussed earlier, a field 218 be provided to allow the user to specify which paths the topology manager 130 will display, with “0” indicating all paths, “−1” indicating only redundant paths, “−2” indicating all paths a user has visited, and numbers greater than “0” indicating the number of user desired paths. As well, a box 220 displays the number of paths found, a box 222 displays the number of redundant paths found, a box 224 displays the run time, and a box 226 displays the number of iterations run.

The control panel 200 also provides a button 228 that causes the network topology manager 130 to display the streams in the selected network domain (e.g., in table format, graphical format, etc.), and a button 230 that causes the topology manager 130 to display all paths. A button 232 causes the topology manager 130 to create a chart showing the individual paths and their precise timing in the domain as a separate path for comparison purposes, as discussed later herein. A button 234 causes the topology manager 130 to create a switch table or Gate Control List (GCL) table with corresponding QBV entries for the devices in the domain and also generates a timing graph for the devices in the network domain. Note that both the chart created via button 232 and table created via button 234 can be present simultaneously, and can also be invoked automatically after completion of the path calculations, without having to use these buttons. The buttons are for convenience and manual control of the process only. In some embodiments, button 232 (or another designated button) also causes the topology manager 130 to automatically propagate and apply the GCL table to the devices in the domain to automatically configure to these devices according to the GCL table. A GCL table with QBV entries, which is a reference to IEEE 802.1Qbv, contains a list of control parameters that control when each type of message traffic has access to the devices in the network. The topology manager 130 may then download the GCL table to the devices in the network to define transmission time slots for the network traffic queues in the devices. An example of a GCL table that is automatically created by the topology manager 130 in accordance with IEEE 802.1Qbv is provided below in Table 1. A button 236 causes the topology manager 130 to print the domain topology.

TABLE 1
Exemplary GCL Table

G( 1) P= 1 S= 1918 D= 672
Port 2
G( 0) P= 255 S= 0 D= 3761
G( 1) P= 1 S= 3761 D= 672
Port 3
no gates
GCL TABLE Y
Port 1
no gates
Port 2
G( 0) P= 1 S= 0 D= 747
GCL TABLE C
Port 1
no gates
Port 2
G( 0) P= 255 S= 0 D= 1918
G( 1) P= 1 S= 1918 D= 672
Port 3
G( 0) P= 255 S= 0 D= 3761
G( 1) P= 1 S= 3761 D= 672
GCL TABLE D
Port 1
no gates
Port 2
no gates
GCL TABLE W
Port 1
no gates

The NetworkCanvas provides a UI that resembles a canvas in appearance for allowing a user to “draw” or otherwise visually create a physical deployment of the networking artifacts on the canvas, including adding and connecting the industrial devices, wireless access points, 5G devices, and so forth, and their cabling and/or wireless coverage. The UI can be rendered as either a 2D or 3D representation of the topology in some embodiments, where the main advantage of a 3D representation is greater readability. As the principles of operations are almost identical for all static, non-mobile networks, for illustrative purposes the embodiments herein focus on a wired (e.g., Ethernet) network.

The DeviceCatalog provides a catalog or library that contains device objects representing various devices and their parameters obtained from online and/or offline sources of data for such devices. The offline device data may be imported from digital data sheets (DDS) via one or more internal or external device databases, such as the one or device databases 134 in some embodiments, and may be represented using images of automation components where available, such as in the case of OPCUA devices. Online device data may be obtained through a known device discovery process of the CNC-TDE, such as the Link Layer Discovery Protocol (LLDP) or similar protocol. Implementation of the DeviceCatalog can be local (i.e., on the system where the CNC 138 is running), or remotely accessed from credible device repositories such as manufacturer URLs or OPCUA URLs, and the like. The catalog maintains online and offline data set version of the device data sheets, with preference for the online data sets. Users may then update, edit, add, delete, and generally manage the devices in the catalog or library via a user interface therefor.

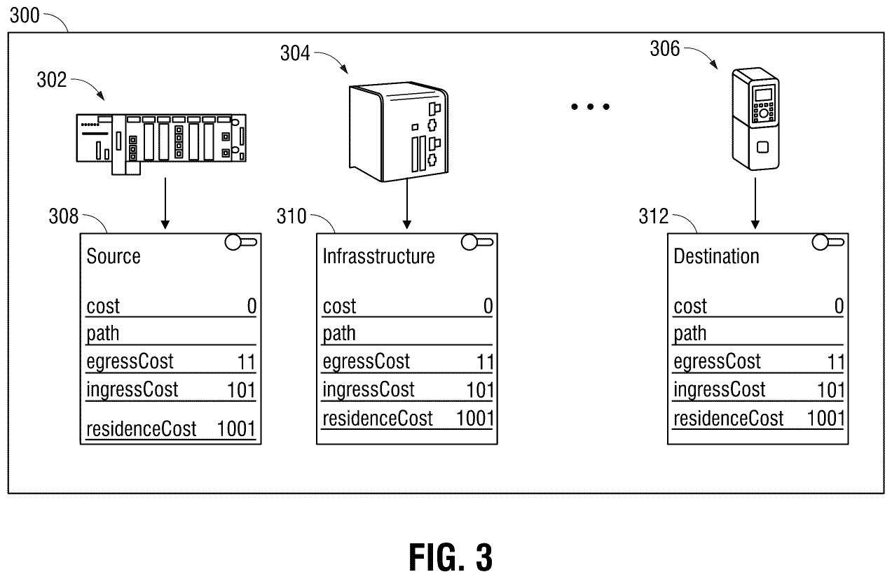

FIG. 3 illustrates an exemplary library 300, or rather the user interface therefor, containing examples of device objects that represent various industrial devices that a user may use to create a domain. The device objects shown in the exemplary library 300 include an industrial source device object 302, an infrastructure device object 304, and an industrial destination device object 306. Many other types of industrial device objects may also be included, but are omitted here for economy. Each device object may have one or more visual representations associated with a device that show the properties and parameters of the device. For example, a source parameters table 308 may visually represent the industrial source device object 302, an infrastructure parameters table 310 may visually represent the infrastructure device object 304, and a destination parameters table 312 may visually represent the industrial destination device object 306. The parameters table for a device object may be displayed adjacent to the device object in the library 300, or a user may right-click on the device object to bring up the parameters table for the device object. The user may then select and use the various visual representations 308, 310, 312 to construct a new domain or add them to an existing domain by dragging and dropping or copying and pasting the visual representations to a new or existing canvas. Note that the device catalog (DeviceCatalog) may also provide the device objects in the form of a listing, for example, by device type and model instead of graphical representations.

Depending on the application, each parameters table 308, 310, and 312 may show several key elements of TSN related parameters, including one or more of: “Ports”—represents a port and its potential TSN parameters, a device may have more than two ports if serving as a network bridge; cost-refers generally to time required in a given unit of time and may or may not be displayed depending the desired implementation (shown here as “0” for illustrative purposes only); “ingressCost”—time required for a frame to be received by a device; “egressCost”—time required for a frame to be transmitted from a device; “Speed”—the speed of a port; “Type”—a type of interface used for connectivity (e.g., Ethernet, SPE/APL, WiFi6, 5G, etc.); “residenceCost”—time required for a frame to transition through a device; “DeviceUniqueTypeID”—a parameter set that uniquely identifies the device type; “DeviceUniqueID”—a parameter set that uniquely identifies an instance of the device within a type; “Streams”—a list of streams associated with a device; “isTarget”—a device is marked as “targetDevice” if its stream is selected as a subscriber and may or may not be displayed depending the desired implementation; “paths”—a list indexed by “processingLevel,” where processingLevel is incremented every time a new path is discovered toward a device; and “path”—the path with the lowest cost from among the available devices paths (device.paths) and may or may not be displayed depending the desired implementation (shown here as empty for illustrative purposes only).

The ApplicationCatalog provides a catalog or library that contains application objects and their association with the industrial devices. From a TSN perspective, the ApplicationCatalog contains a collection of CUC interpretations of a network application (e.g., automatic cheese slicer). It serves as an interaction point for the CNC 138 with the network application. Some key elements of TSN related parameters for the stream may include, for a talker device of the stream, one or more of: “sourceDevice”—a device to which a stream is associated; “destinationDevice”—a set of devices to which a stream is associated; “interval”-time interval in which a stream produces data, it is expected that an application will produce data at least once in an interval; “publishingOffset”—an offset within the interval at which a device produces stream data on the network; “maxMessageSize”—maximum size of the application datagram to be transmitted in a single network message within an interval; “priority”—the priority of the streams within the application and consequently in the network. Similarly, some key elements of TSN related parameters for the stream may include, for a listener device of the stream, one or more of: “destinationDevice”—a device to which a stream is associated; “receivingOffset”—an offset within an interval at which a device is expected to receive stream data; “streamCost”—total allowed time for message frame transmission (i.e., receivingOffset-publishingOffset).

In the foregoing, the publishingOffset time and the receivingOffset time for a given stream define the time span within which a message frame must be received by a listener node from a talker node via a given path for that stream. The path may thus be referred to as a “time bound” path. Based on the foregoing, the minimum amount of time required for a message frame to traverse a given device (i.e., minimum transit time) can be found by adding the ingressCost, residenceCost, and egressCost for the device. Similarly, the latency of a path between a talker node and a listener node in a network can be calculated by adding the minimum transit time needed for a message frame to traverse each device in the path. The lowest latency path can be found by calculating each available path between a talker node and a listener node in the network and determining which path has the smallest latency. However, while such a brute force can suffice, embodiments of the present disclosure can also find the lowest latency path without actually calculating all possible paths.

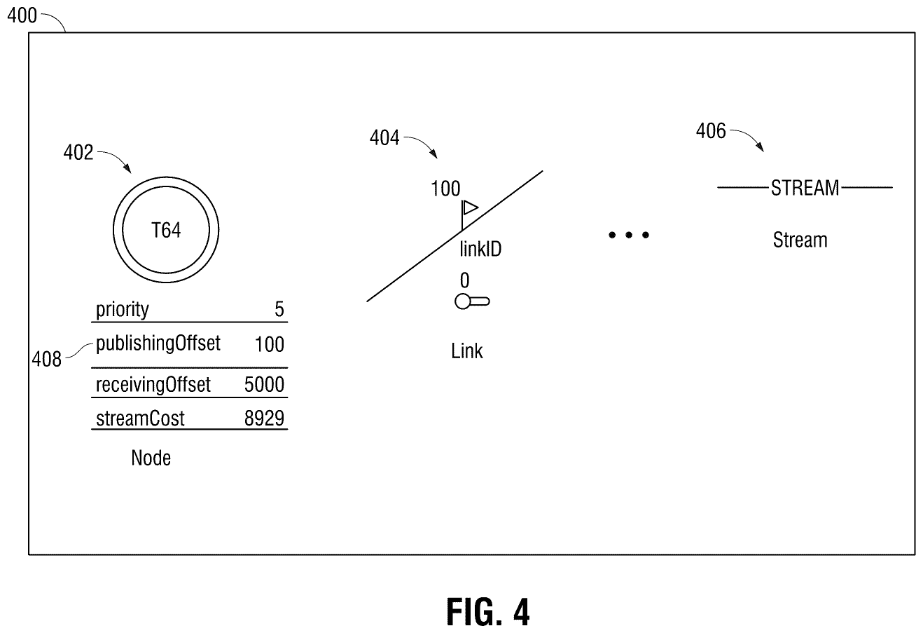

FIG. 4 illustrates an exemplary library 400, or rather a user interface therefor, containing examples of application objects that a user may use to create a domain or network. Users may use the user interface to update, edit, add, delete, and generally manage the application objects in the catalog or library. The application objects shown in the exemplary library 400 include a node object 402, a link object 404, and a stream object 406. Many other types of application objects may also be included within the scope of the present disclosure. The node object 402 may include a letter indicating the role associated with the object (e.g., “T” for talkers and “S” for listeners) and a number indicating the size of the message frames used by that device (e.g., “64” for 64 bytes. In some embodiments, the link object 318 may include a number indicating the link speed (e.g., “100” for 100 Mbps), and a flag, the color of which indicates configured speed and is user-customizable (e.g., yellow is 10 Mbps, green is 100 Mbps, blue is 1 Gbps, etc.). It will also be appreciated that the flag is exemplary only and other symbols besides a flag may also be used within the scope of the present symbol can be used.

Some objects may have a visual representation associated with the object that shows the properties and parameters of the object. For example, the node object 402 may have a node parameters table 408 associated therewith. The properties and parameters for a application objects may be displayed with the object, or a user may right-click to bring up (or pin down) the properties and parameters. The user may then select and use the various visual representations to construct a new domain or add them to an existing domain by dragging and dropping or copying and pasting the visual representations to a new or existing canvas. Note that the application catalog (ApplicationCatalog) may also provide the application objects in the form of a text based listing of the application objects.

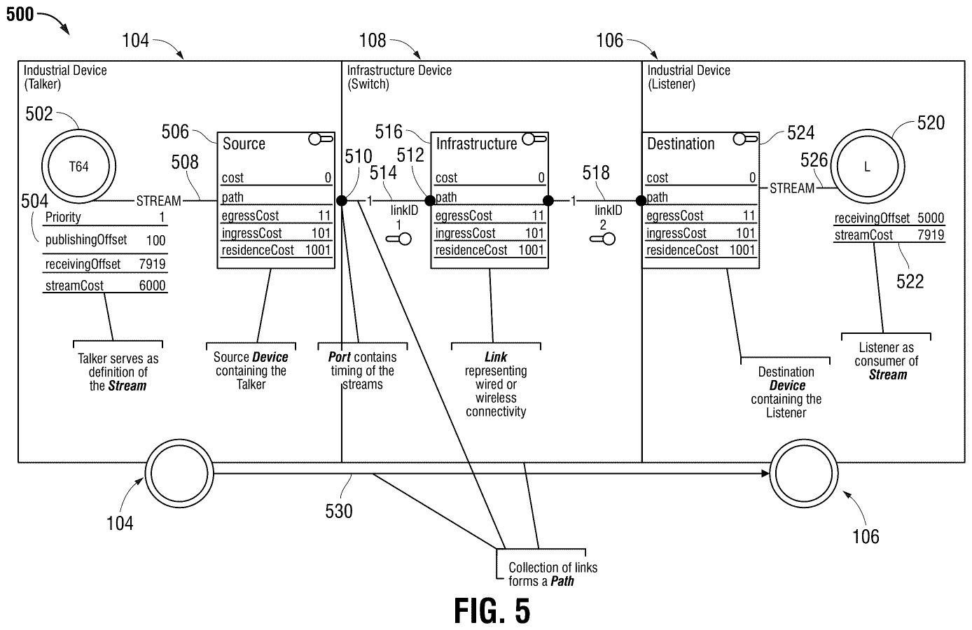

FIG. 5 illustrates an exemplary canvas showing a network domain 500 composed of a minimal number of devices and streams to illustrate the constructs and interactions herein. The network domain 500 depicted in the figure is a representation of the network 102 from FIG. 1 where all values in the domain 500 are arbitrary and provided for illustration purposes only. The discussion that follows describes construction of network topologies like the domain 500 to illustrate several of the features and capabilities of the network topology manager 130, and also to capture the user experience and the value provided by the process of creating a network for OPCUA/TSN industrial applications as disclosed herein.

In FIG. 5, the industrial device 104 in the network 102 is represented as a talker node 502 having a 64-byte frame size (i.e., “T64”) with a node properties table 504 and source device properties table 506 having the parameters listed therein (e.g., message priority “1”), stream connectivity 508. The industrial device 104 is connected to the infrastructure device 108 in the network 102 via their respective ports 510 and 512 over a link 514, which may be a 1-meter cable in this example, as indicated by the “1” on the link 514. The infrastructure device 108 may be an Ethernet bridge and is represented by a switch properties table 516 having the parameters listed therein. A second link 518, which may be another 1-meter cable, connects the infrastructure device 108 to the industrial device 106 via their respective ports (not expressly labeled). The industrial device 106 is represented here as a listener node 502 (i.e., “L”) with a node properties table 522 and listener device properties table 524 having the parameters listed therein, and stream connectivity 526.

As can be seen, the talker 502 publishes data at a publishing offset (publishingOffset) of 100 time units from the start of a communication “interval,” and the frame is expected to arrive at the listener 520 by no later than a receiving offset (receivingOffset) of 5000 time units into the interval. The time units are units of time used throughout the system to represent seconds or its fractions (e.g., millisecond, microsecond, etc.). Thus, the message travel time (i.e., latency) for the path between talker 502 and listener 520 is a compilation of links, ports, and devices and their timing characteristics as encountered along the path.

The graphical representations of the network devices in the domain 500 and their parameters can be obtained in several ways, including offline and online. The main difference between the offline and online mode is the physical presence of the network devices themselves. In the offline mode, the parameters for the devices originate from the offline device catalog (DeviceCatalog), including device data sheets, whereas in the online mode, the devices are physically present in the network and their parameters are acquired from the devices directly during a network discovery process (e.g., by using NETCONF, OPCUA, Link Layer Discovery Protocol (LLDP), etc.). The local device catalog may be packaged together with the network topology manager 130 in some embodiments, then updated later on a regular basis with the content from remote online device catalogs. In some embodiments, the network topology manager 130 may combine offline device data from device datasheets with online device data to form a complete state of the device.

To draw the domain 500, a user selects devices from the device catalog and graphically places them on a canvas. The devices can be dragged and dropped onto the canvas from the device catalog (e.g., library 300), they can be copied and pasted on the canvas, or they can be placed onto the canvas in some other suitable way. The devices are then displayed on the canvas with all their ports and complementary parameters, as depicted in FIG. 5. The user can then connect the devices to each other using link objects that represent cables in the real world. In some embodiments, the user can simply select a port in the device and draw a line connecting that port to the port in another device. This motion automatically inserts a link object that links the two devices and assigns a link ID (e.g., link ID 1) to the link. The user can also manually insert a link by dragging and dropping a link object there. The link object is a logical entity of the network topology manager 130, and serves to connect devices and respective ports to each other. The user repeats the process until the network resembles the planned network (e.g., network domain 500). The user can select all or part of the available devices and topology to form a domain. The user then instructs the network topology manager 130 to establish or otherwise define the domain 500, for example, by clicking button 206 (CNC-createDomain) in the control panel 200 from FIG. 2.

Once the domain 500 is created, the user can draw a line 530 between the two nodes 104 and 106 to create a stream between the nodes. The user can then click button 210 (CNC-findAllPaths) or button 212 (findPubSub) in the control panel 200 to find all paths in the domain 500, as discussed further herein, and calculate message timing through the various paths, as discussed further herein.

In some embodiments, the canvas can represent the physical space where the network is to be deployed to scale, and the user can draw the link in such a way that it follows a predefined installation path and avoids real world obstacles. This allows the topology manager 130 to automatically calculate the distance of the link and check for timing and other violations. If there are violations, the network topology manager 130 can suggest insertion of an additional device to resolve the violations. If data for the linked devices is present (i.e., online), the topology manager 130 can access the data to validate the link, including but not limited to checking device and port identification, cable length, speed, duplex, and so forth.

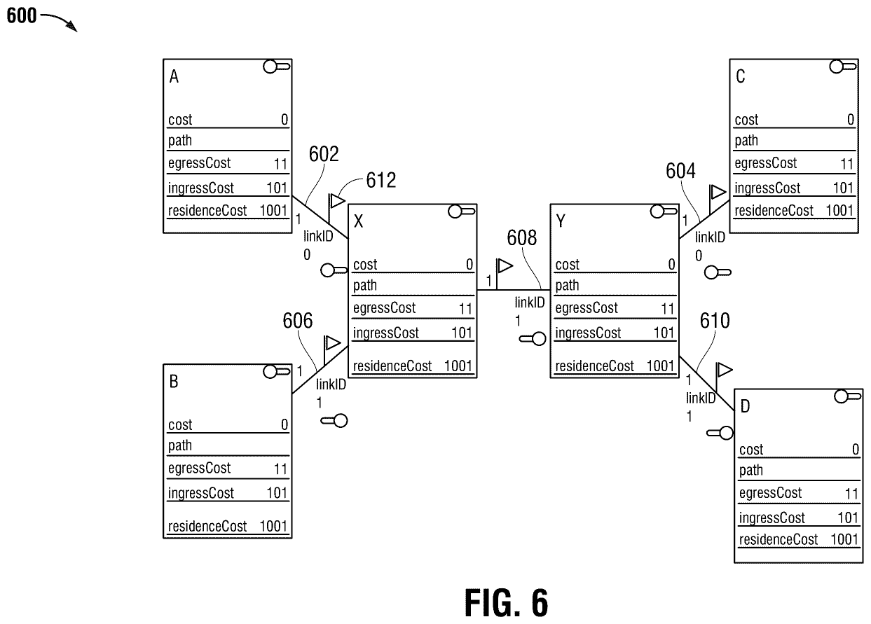

FIG. 6 depicts an exemplary user interface 600 that shows the network topology manager 130 automatically identifying timing violations. The figure shows a network in which the user has graphically placed devices A & B, devices X & Y, devices C & D, and their respective links on the canvas, but in a way that created a bottleneck in the network based on the parameters for each device. Selecting the various devices and clicking button 212 (findPubSub) in the control panel 200 causes the network topology manager 130 to automatically calculate message timing for the devices. Based on the message timing, the network topology manager detects that devices X and Y will create a bottleneck in the network 600 that will cause links 602 and 604 to have timing violations. These links 602 and 604 are depicted using a red color to indicate the timing violations. Meanwhile, the topology manager 130 detects that links 606, 608, and 610 have acceptable timing, and therefore depicts these links using another color, such as a blue color. Colored flags may also be placed on the links in some embodiments to indicate link speed, with green flags 612 indicating 1000 Gbps speed, for example, and other colors indicating other link speeds. It should be noted that the selection of which colors to use with which representations herein may be made by a user or predefined by default within the topology manager 130. The user can thus quickly see where the bottleneck has formed in the network 600 and also see which links are affected by the bottleneck. Such a topology manager 130 can greatly assist the user with designing and debugging time-sensitive network applications.

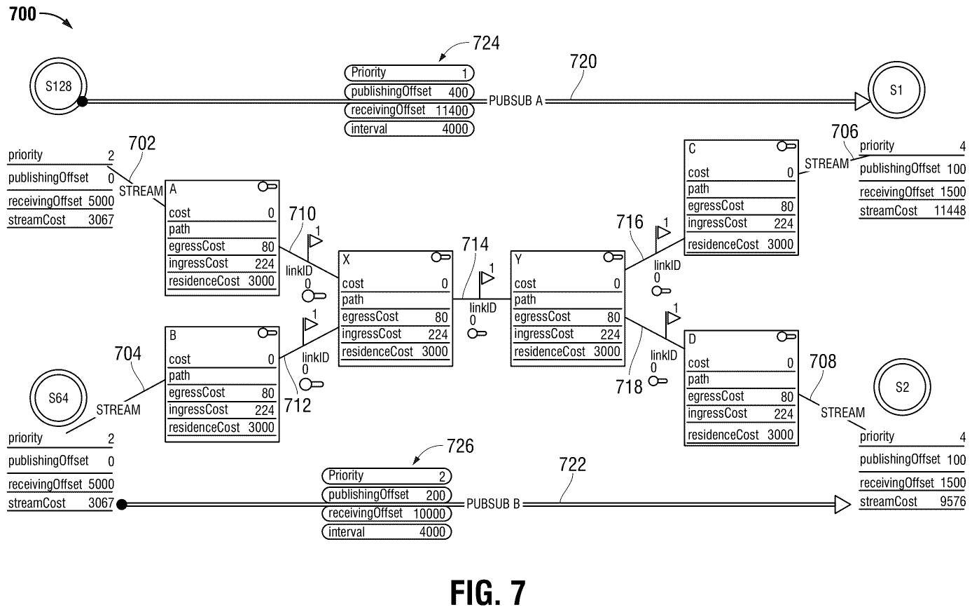

Turning next to FIG. 7, an exemplary user interface 700 is depicted that shows how a user may deploy streams from the application library 400 (ApplicationCatalog) on a network, describe the data quantity and timing requirements of the stream, as well as designate talkers and listeners. As mentioned above, the application library 400 provides application objects (e.g., talker and listener nodes, links, streams, etc.) that the user may drag and drop onto a canvass to define a particular network application. Thus, the user can simply drag and drop a talker node on a source device to designate the device as a talker, and drag and drop a listener node on a destination device to designate the device as a listener, and so on. The talker and listener nodes have message priority and timing parameters that are specified by the user while creating or defining an application. Each stream link connecting the various devices is basically a logical entity of the network topology manager 130 which associates talkers and listeners to their respective devices.

In some embodiments, the network topology manager 130 may render the talker and listener nodes using different colors for easier visual correlation and tracking of links between the nodes. For example, node S128 may have a black color, while node S64 may have a blue color, whereas node S1 may have a yellow color, and node S2 may have a purple color. Alternative colors besides the ones mentioned here may of course be used within the scope of the disclosed embodiments.

In FIG. 7, the user has defined two streams for the network using two talkers, S128 and S64, two listeners S1 and S2, and six devices A, B, C, D, X, and Y arranged as shown. Once the user drags and drops nodes S128 & S64 and S1 & S2 onto their respective devices A & B and C & D, the network topology manager 130 automatically creates a link between the nodes and the devices, indicated at 702 & 704 (“STREAM”) and 706 & 708 (“STREAM”), respectively. If not already done by this point, the user then draws a line (or drops a link) between the six devices A, B, C, D, X, and Y, and the topology manager 130 creates a link between the devices, as indicated at 710, 712, 714, 716, and 718. The colored flags on the links indicate link speed, with green flags indicating 100 Mbps speed, and the adjacent numbers indicate cable length, with “1” indicating one meter. The user then draws a line between talker (S128) and listener (S1), and the network topology manager 130 creates a stream “PUBSUB A” between the two nodes using, for example, double blue lines 720. In the same fashion, stream “PUBSUB B” is created when the user draws a connection between talker (S64) to listener (S2), as indicated by double blue lines 722.

Each stream 720 and 722 has its own communication characteristics, some of which are displayed in stream labels 724 and 726, respectively, attached to the streams 720 and 722. In the present example, each stream label 724, 726 shows the priority level of its stream, the publishing offset (publishingOffset), the receiving offset (receivingOffset), and the interval. These communication characteristics of each stream are defined by the user and override any conflicting device configurations (i.e., the stream dictates the communication characteristics while the devices contribute device specific characteristics).

PUBSUB A—has priority 1 (higher than priority 2). The node labeled “S128” residing in device A is attached to stream 720 and sends a 128-byte frame on the stream. The stream starts its message transmission at a publishing offset of 400 time units (i.e., 0.4 milliseconds) into the communication interval. The arrow at the end of the stream indicates the destination, node “S1.” The message is expected to arrive by a receiving offset of 11400 time units (i.e., 11.4 milliseconds) into the communication interval.

PUBSUB B—has priority 2 (lower than priority 1). The node labeled “S64” residing in device B is attached to the stream 722 and sends a 64-byte frame on the stream. The stream starts its message transmission at a publishing offset of 200 time units (i.e., 0.2 milliseconds) into the communication interval. The arrow at the end of the stream indicates the destination, node “S2.” The message is expected to arrive by a receiving offset of 10000 time units (i.e., 10 milliseconds) into the communication interval.

Once the network is constructed and the links between devices established, the user can click button 210 (findPubSub) or button 212 (findPubSub) in the control panel 200 (FIG. 2) to automatically calculate message timing for the various links and streams. It should be noted that in order to identify the streams and devices that belong to a given domain, the user first selects the desired talkers, listeners, and devices on the canvas, then assigns them to the domain by clicking button 206 (CNC-createDomain) in the control panel 200. The network topology manager 130 then synchronizes the timing of these devices with each other using an appropriate time synchronization protocol, such as IEEE 802.1AS. The network topology manager 130 also checks that all devices selected for the domain are IEEE 802.1AS capable via deviceCatalog) and that they are directly interconnected (i.e., there are no non-802.1AS devices between them). As mentioned earlier, the network topology manager 130 may show links with timing violations in red color and those with acceptable timing in blue color, in some embodiments.

In the network shown in FIG. 7, the network topology manager 130 has found that the message frames being conveyed will interfere with each other on the network. Specifically, the topology manager 130 has found that the streams for S64 and S128 are transmitted on the network in such a way that a message from S64 (with priority P2) will cause a delay for a message from S128 (with higher priority P1), due to the S64 message being received at switch X, and subsequently forwarded, before the S128 message is fully received at switch X. One example way to depict the interference is to show the affected links 712, 714, and 718 using red lines.

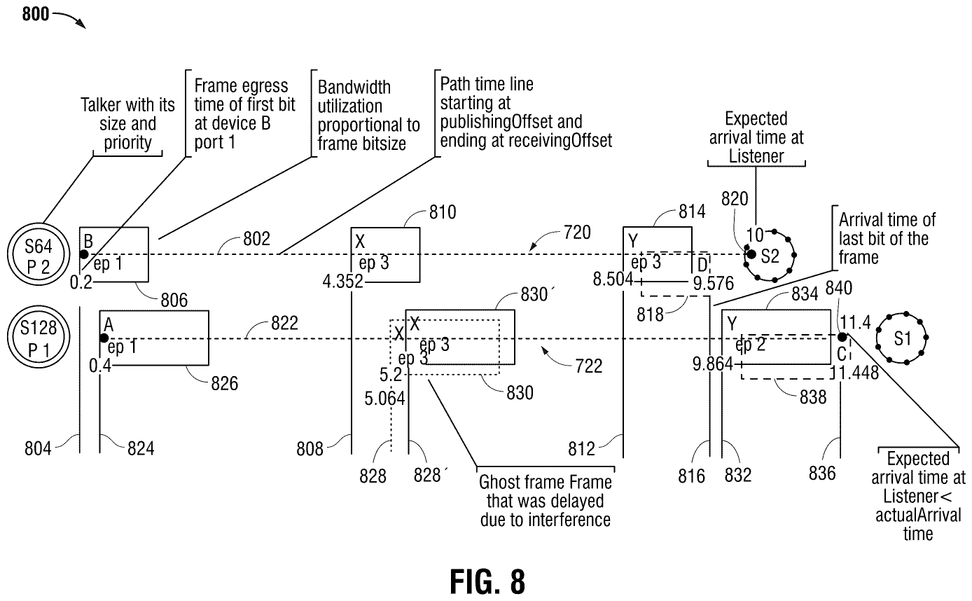

FIG. 8 illustrates an exemplary visualization of the above scenario. In the figure, the network topology manager 130 uses a communication timing diagram (CTD) 800 to depict the streams for S64 and S128. This can be done, for example, by selecting the network and clicking button 232 (CNC-makeChart) in the control panel 200. As can be seen, each talker is depicted with a circle that includes a number indicating its message frame size and also its message priority (e.g., “S64 P2” for talker S with 64-byte frames and priority 2.

The first vertical line (e.g., lines 804 and 824) for each talker displays the time at which the first message frame leaves the device (e.g., device B and A, respectively) that hosts the talker (e.g., 0.2 for device B, 0.4 for device A). Each rectangular block (e.g., blocks 806 and 826) represents the time that a frame spends “on the wire” and has a length that is proportional to the size of the frame in bytes (i.e., byte time). The start of each block represents the first bit in a message frame and is aligned with the first vertical line mentioned above. Each block is marked with a corresponding device designation and egress port number (e.g., “B ep1” in block 806 means device B and egress port 1, “A ep1” in block 826 for device A and egress port 1). Each block can also be labeled with the size of the block (timeSize) and the time of the last bit in some embodiments. Each subsequent line and block pair represents a message frame departure time on a corresponding device in the path. Thus, for example, “X ep3” & “4.352” means message frame departure at time 4.352 (line 808) from egress port 3 in device X (block 810), and “Y ep3” & “8.504” means departure at time 8.504 (line 812) on egress port 3 in device Y (block 814).

In some embodiments, in order to show the size of the affected links in perspective, the end portion of a stream is shown with the last block in the stream and the destination node in dashed lines. Here, the last vertical line (e.g., lines 816 and 836) represents arrival of the last bit in the frame (e.g., blocks 818 and 838) at the destination device (e.g., devices D and C) that hosts the listener (e.g., “9.576” means arrival at time 9.576 on device D). Note that the image of the last frame in the temporal domain would be reversed from the previous ones. Thus, the last vertical lines here, lines 816 and 836, are attached to the right side of dashed blocks 818 and 838, which represent the frames arriving at their destination devices D and C, respectively.

Dashed horizontal lines (e.g., lines 802 and 822) indicate the desired latency (i.e., publishingOffset to receivingOffset) for the streams. Each latency line ends at an endpoint (e.g., endpoint 820 and 840) with an adjacent number (e.g., “10” and “11.4”) indicating the expected message frame arrival time (receivingOffset). The particular color used for each latency line indicates timing success or lack thereof. For example, a green color represents timing success for latency line 802 of node S64, while a red color represents timing failure for latency line 822 of node S128.

From the visualization provided by the communication timing diagram 800, a user can quickly see that the frame from S64 is transmitted to switch X by device B through egress port 1 at time 0.2, as indicated by line 804 and block 806. The frame is subsequently forwarded by switch X through egress port 3 to switch Y at time 4.352, as indicated by line 808 and block 810. Switch Y thereafter forwards the S64 frame through egress port 3 to device D at time 8.504, as indicated by line 812 and block 814. The last bit in the frame arrives at device D at time 9.576, as indicated by line 816 and block 818. This arrival time is before the expected arrival time 10, and hence endpoint 820 of latency line 802 is shown terminating within node S2, and a green color is used to render that latency line.

Meanwhile, the frame from S128 is transmitted to switch X by device A at time 0.4, as indicated by line 824 and block 826. Switch X is supposed to forward the S128 through egress port 3 frame to device Y at time 5.064, as indicated by line 828 and block 830. This does not happen, however, because egress port 3 of switch X is still transmitting the frame from S64 at that time, which frame arrived before the arrival of the frame from S128. Hence, the network topology manager 130 shows line 828 and block 830 as dotted lines (i.e., a “ghost” block). Switch X instead begins forwarding the S128 frame through egress port 3 at time 5.2, after transmission of the S64 frame is completed, as indicated by line 828′ and block 830′. The delayed transmission by switch X causes a compounded delay at switch Y, which does not begin forwarding the S128 frame through egress port 2 until time 9.864, as indicated by line 832 and block 834. This, in turn, causes a compounded delay in the arrival of the frame at device D, at time 11.448 instead of the expected time 11.4, as indicated by line 836 and block 838. Latency Thus, in this example scenario, the user easily sees that the lower priority S64 frame interferes with the higher priority S128 frame.

Assume further, for example, that S128 in the above scenario has a critical application timing that is not adjustable. In such instances, the network topology manager 130 allows the user to adjust the timing of the message frames by dragging or sliding the frames forward or backward along their stream or otherwise modifying the values in the appropriate stream parameter fields, then recalculating the timing based on the new positions of the frames (e.g., by clicking button 210 (CNC-findAllPaths) or button 212 (findPubSub) in the control panel 200). The network topology manager 130 includes a path and TAS calculation engine, CNC-PE (FIG. 1), that can calculate frame timing using TAS rules to automatically produce time aware gates for devices.

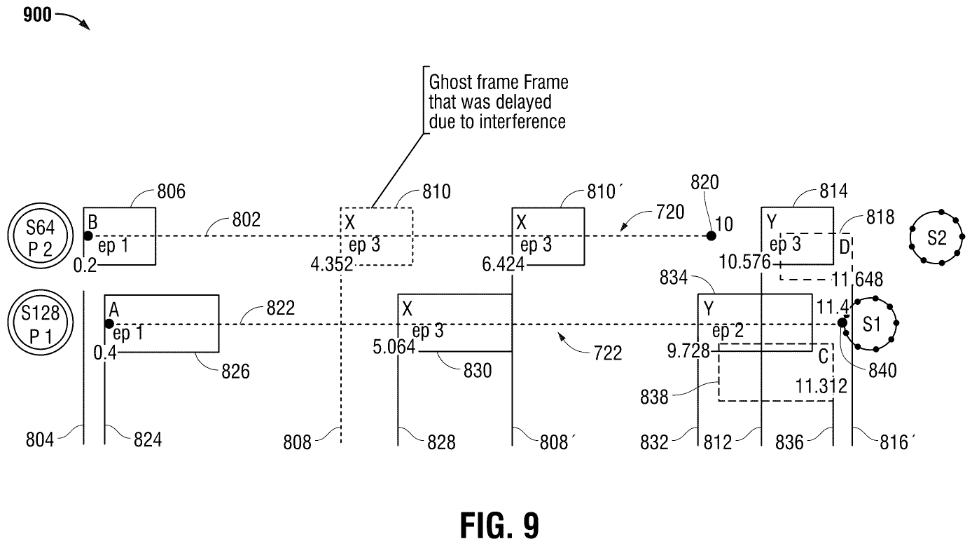

FIG. 9 illustrates an exemplary visualization of the above scenario via another communication timing diagram 900. In the figure, the user has attempted to resolve the interference from the S64 frame by moving back the transmission of the frame at switch X until time 6.424, as indicated by line 808′ and block 810′. This can be done by sliding or dragging block 816 to the right and clicking button 210 (CNC-findAllPaths) or button 212 (findPubSub) in the control panel 200. Doing so will cause the topology manager 130 to update one or more stream parameters (see stream labels 724 and 726 in FIG. 7) and recalculate the paths, then redraw the timing diagram 900. The S128 frame can now be transmitted by switch X as planned at time 5.064, as indicated by line 828 and block 830. As a result, switch Y can now forward the S128 frame as planned at time 9.728, as indicated by vertical line 832 and block 834. This allows the S128 frame to arrive at device C at time 11.312, ahead of the expected arrival time 11.4, as indicated by line 836 and block 838. However, the delay in forwarding the S64 frame at switch X causes an equal delay at switch Y, as indicated by line 812 and block 814. This, in turn, causes the S64 frame to arrive late at device D, at time 11.648 instead of the expected arrival time 10, as indicated by vertical line 816 and block 818. Hence, the endpoint 820 of latency line 802 is shown terminating before it reaches node S2.

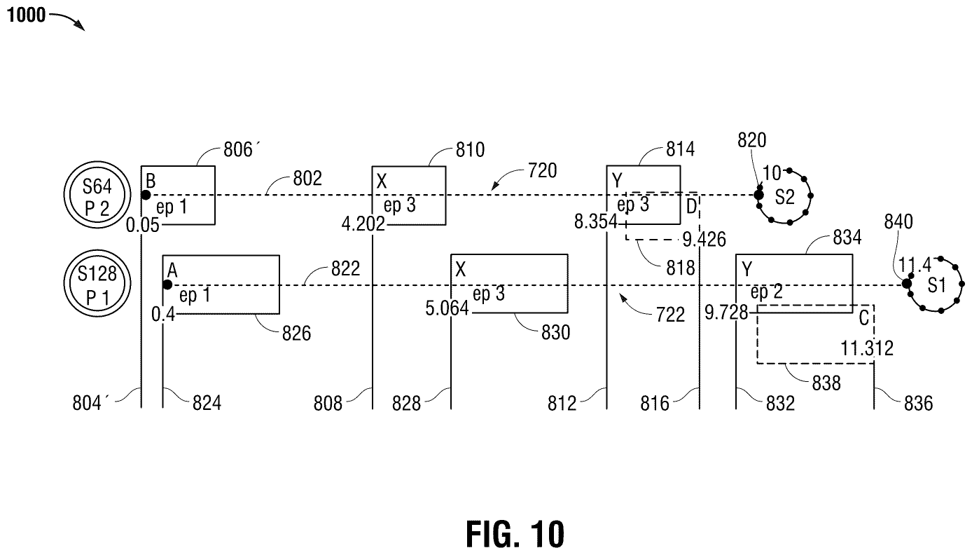

FIG. 10 illustrates an exemplary visualization of the above scenario, but with adjusted offsets, via a communication timing diagram 1000. This time, the user has attempted to resolve the interference from the S64 frame by moving forward the transmission of the frame at device B to an earlier time 0.05, as indicated by line 804′ and block 806′. Again, this can be done by sliding or dragging block 806 to the left and clicking button 210 (CNC-findAllPaths) or button 212 (findPubSub) in the control panel 200. The S64 frame now arrives earlier at switch X, and can be transmitted sooner by switch X, at time 4.202, as indicated by line 808 and block 810. This leaves just enough time for switch X to complete transmission of the S64 frame and begin transmitting the S128 frame without any delay. With the interference now resolved, the network topology manager 130 displays both latency lines 802 and 822 using green lines. The final adjustment to the timing of the S64 frame may then be propagated to the physical devices themselves by clicking button 234 (CNC-makeSwitchTable) in the control panel 200 to create a GCL table, and downloading the GCL table to the devices. Button 234 calculates proposed GCL tables for all devices and displays them on the screen. The topology manager 130 can then deploy the tables to the devices automatically according to a deployment schedule, or the tables can be deployed to the devices at as directed by the user.

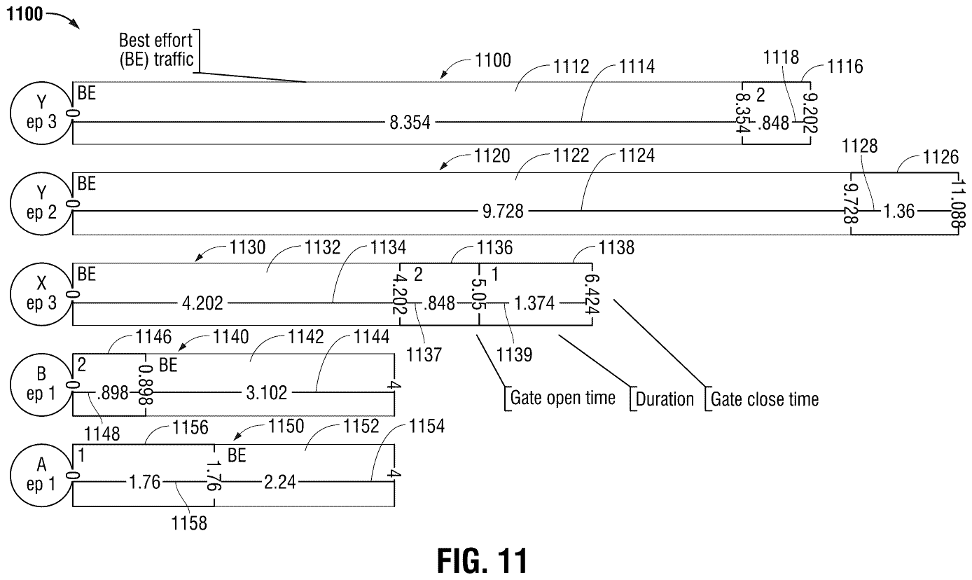

FIG. 11 shows an exemplary feature of the network topology manager 130 that allows a user to visually verify TAS (Time Aware Shaper) configurations for devices in a network using a TAS gate timing view (GTV) 1100. In this example, the user has selected devices A, B, X, and Y from network of FIG. 7 to display in the TAS gate view 1100 (e.g., by clicking button 232 (CNC-makeSwitchTable) in the control panel 200). Alternatively, the network topology manager 130 may automatically select the devices for display in this view based on which devices were involved in message frame transmission. In either case, for each device and each egress port thereof, the network topology manager 130 displays a time graph that may resemble a Gantt chart in appearance. Thus, there is a time graph 1110, 1120, 1130, 1140, and 1150 respectively, for each of device Y and egress ports 2 and 3, device X and egress port 3, device B and egress port 1, and device A and egress port 1.

Each of the time graphs 1110, 1120, 1130, 1140, and 1150, respectively, includes a “best effort” interval 1112, 1122, 1132, 1142, and 1152. The “best effort” interval is a period of time during which no priority traffic is scheduled on the device and the device is free to use its “best effort” to transmit other message frames as needed. Each of the time graphs, respectively, also includes a timeline 1114, 1124, 1134, 1144, and 1154 that specifies the duration of the “best effort” interval for that time graph. Each of the time graphs, respectively, also includes a generally rectangular block 1116, 1126, 1136, 1146, and 1156, the size of which is proportional to the amount of time that a given device spends transmitting a message frame through a given port. Each of the blocks respectively includes a timeline 1118, 1128, 1139, 1148, and 1158 within or adjacent to the blocks that specifies the duration of the block. Note that for device X a second message frame was transmitted on egress port 3, as indicated by block 1138 and timeline 1139 therein, resolving the bottleneck on device X discussed earlier. Each block 1116, 1126, 1136, 1138, 1146, and 1156 also includes a priority level (e.g., “1” for priority 1, “2” for priority 2, etc.) for the message frame represented by the block. For a given block, the number on the left edge of the block indicates the time when the device opened a gate for the block, while the number on the right edge of the block indicates the time when the device closed the gate for the block.

From this view, the user can easily see that device X opened a priority 2 gate on egress port 3 and held it for just enough time to allow the S64 message frame to go through, then closed that gate and opened a priority 1 gate for enough time for the device to service the S128 message frame. Meanwhile, the interval that preceded the two message frames is open to the device for “best effort” traffic.

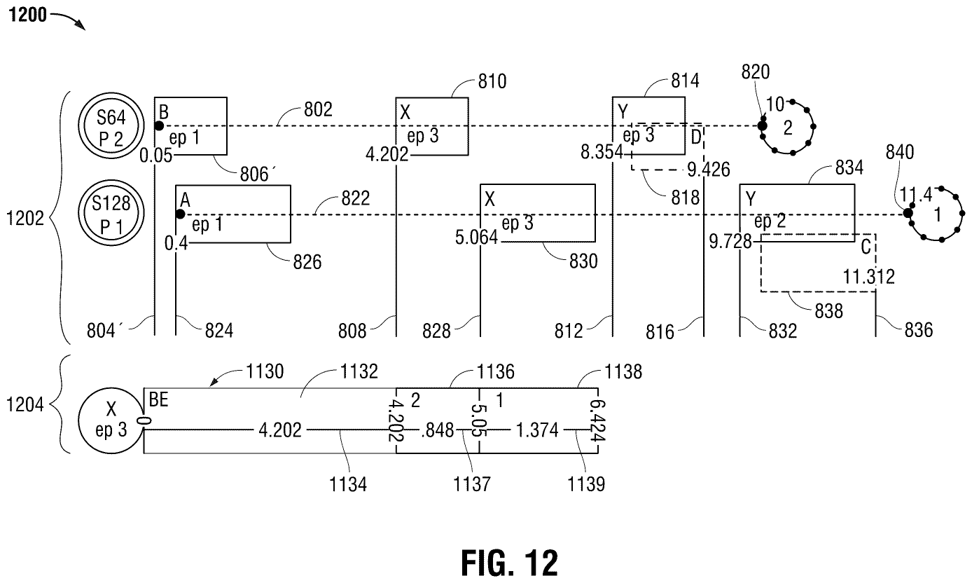

FIG. 12 shows an exemplary feature of the network topology manager 130 that allows a user to combine a communication timing diagram (CTD) like the one shown in FIG. 10 and a TAS gate view (TGV) like the one shown in FIG. 11 into an overlay view 1200. In this example, the network topology manager 130 has displayed the two streams 802 and 822 from FIG. 10 in the top half of the overlay view 1200, generally indicated at 1202, together with the time graph 1130 from FIG. 11 in the bottom half of the overlay view 1200, generally indicated at 1204. From this overlay view 1200, the user can clearly identify which frames belong to which schedules. It should be noted that, for completeness, the entire TAS should be overlayed, as overlaying only part of the TAS can potentially lead to misunderstanding.

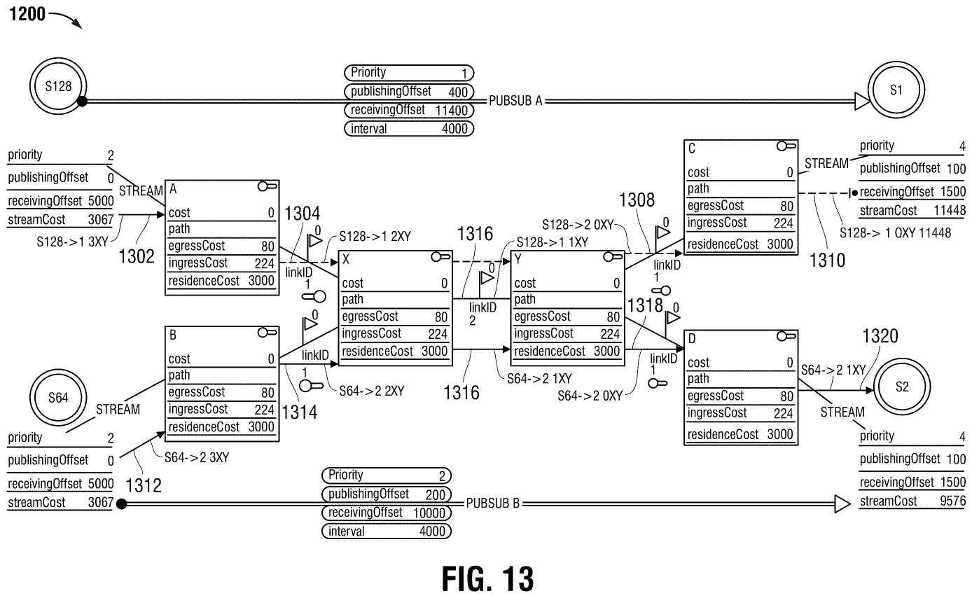

FIG. 13 depicts an exemplary user interface 1300 similar to the one depicted in FIG. 7 in which the network topology manager 130 displays a network using a network topology view. In this example, like in FIG. 7, the user has already selected the devices and links to be included in the network and has defined the network (e.g., by clicking on button 206 (CNC-createDomain) in the control panel 200) based on those selected devices and links. The user then instructs the topology manager 130 to calculate timing for all paths in the network (e.g., by clicking on button 206 (findPubSub) in the control panel 200), and the topology manager 130 then display all paths found. The topology manager 130 proceeds to perform the timing calculations and display the paths found in the network, with different colors used for talker and listener nodes for easier visual correlation and tracking of links between the nodes.

In the FIG. 13 example, the topology manager 130 uses a yellow color for listener node S1 and a purple color for listener node S2. Accordingly, the paths in stream PUBSUB A connecting talker node S128 and listener node S1 are displayed using yellow lines overlaid on or adjacent to each link. Also, dashed lines are used for the path lines to indicate a message timing violation and solid lines are used to indicate acceptable message timing. For example, a dashed yellow line 1302 is displayed on the stream link from talker node S128 to device A, a dashed yellow line 1304 is displayed on the link from device A to device X, a dashed yellow line 1306 is displayed on the link from device X to device Y, a dashed yellow line 1308 is displayed on the link from device Y to device C, and a dashed yellow line 1310 is displayed on the link from device C to node S1. Basic information about the path may also be displayed on the dashed lines in some embodiments. For example, the path information “S128→1 3XY” on the first dashed yellow line 1302 indicates the message originates from node S128, has message priority 1, there are 3 hops remaining at that point, and the message goes through devices X and Y. The path information “S128→1 2XY” on the second dashed yellow line 1304 indicates the same information as above, except there are now 2 hops remaining, and so forth.

In contrast, the paths in stream PUBSUB B connecting talker node S64 and listener node S2 are displayed using purple lines overlaid on or adjacent to each link. Thus, a solid purple line 1312 is displayed on the stream PUBSUB B from talker node S64 to device B, a solid purple line 1314 is displayed on the link from device B to device X, a solid purple line 1316 is displayed on the link from device X to device Y, a solid purple line 1318 is displayed on the link from device Y to device D, and a solid purple line 1320 is displayed on the link from device D to node S2. The path information “S64→2 3XY” on the first solid purple line 1312 indicates the message originates from node S64, has message priority 2, there are 3 hops remaining at that point, and the message goes through devices X and Y. The path information “S64→2 2XY” on the second solid purple line 1314 indicates the same information as above, except there are now 2 hops remaining, and so forth.

In some embodiments, a green color font may be used for the path information on one or more paths to indicate the message timing is acceptable, while a red color font may be used for the path information on one or more paths to indicate a message timing violation. Thus, in the current example, a red font is used for the path information “S128→1 0XY 14448” in the last yellow dashed line 1310 to indicate a message timing violation, since the message arrived at device C at time 11448, but was supposed to arrive at 11440 according to the stream label for that stream (i.e., receivingOffset=11400). In some embodiments, line 1310 may be terminated with a small vertical line and circle, as shown here, to indicate the message failed its timing at this particular point. In contrast, line 1320 is terminated with an arrowhead to indicate the message is within the required timing.

In the foregoing, it should be noted that the network topology manager 130 can be directed to ignore paths that do not meet specified timing requirements, and thereby reduce computation time and diagram complexity for the topology manager 130. It should also be noted that the switching devices (e.g., devices X and Y) are considered, for illustrative purposes only, to be store-and-forward devices, and thus residence time is processed in LIFO (last bit in is first bit out) mode. However, the switching devices can be configured as cut-through devices instead of store-and-forward devices by simply altering the residence time of the devices to a negative value to indicate cut-through residence time, thereby changing the timing calculations to FIFO (first bit in is first bit out) mode.

In some instances, the user may wish to have one or more redundant paths through a network for a given stream, as a backup in case one or more paths in network fails. In such instances, the user may use the network topology manager 130 to manually create one or more redundant paths by drawing connections between devices in the network or by dragging and dropping links between the devices. Alternatively, the user may select the stream and instruct the network topology manager 130 to find all redundant paths for that stream (e.g., by clicking button 210 (CNC-findAllPaths) or button 212 (findPubSub) in the control panel 200). When thus instructed, the CNC-PE of the network topology manager 130 performs a discovery process that find all redundant paths in the network that allows a message frame to travel across the stream. More specifically, the CNC-PE of the topology manager 130 identifies all unique paths that do not share a link or device in the network and calculates the timing for each path. The network topology manager 130 then calculates which path has the lowest latency path from among the redundant paths. In some embodiments, the topology manager 130 is configured to automatically monitor for changes and perform evaluation of the uniqueness of the paths on a continuous basis. The topology manager 130 can also stop its evaluation without analyzing all possible paths, depending on the particular options specified by the user in field 218 in the control panel 200. For example, option “−1” in field 218 tells the topology manager 130 to find all possible redundant paths; however, that does not mean that all paths will be calculated and compared. Instead, the topology manager 130 stops once the redundant paths are found.

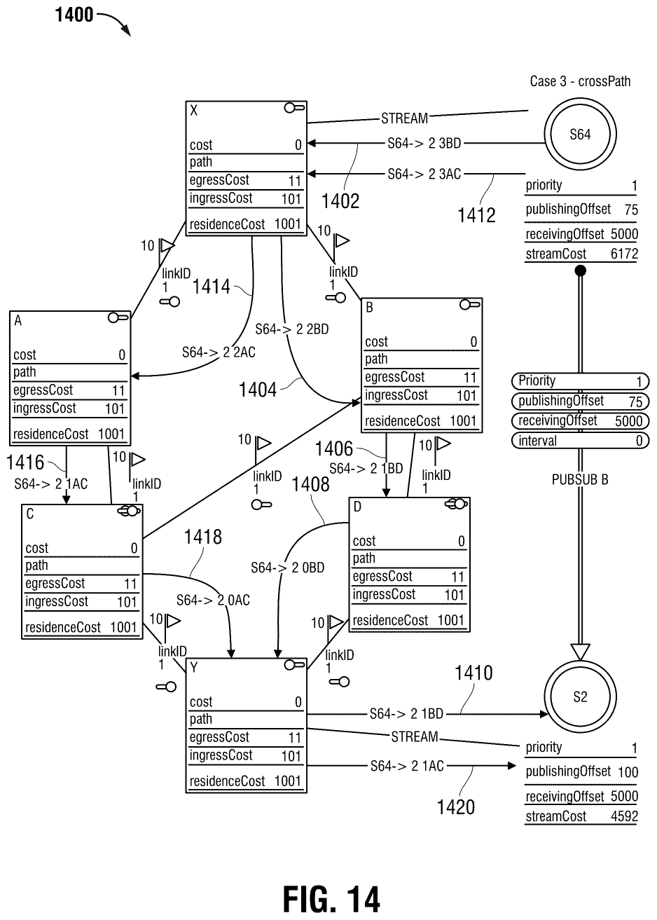

FIG. 14 shows an example of the network topology manager 130 finding and displaying unique redundant paths. The figure shows an exemplary user interface 1400 for the network topology manager 130 in which the user has constructed a network composed of devices A, B, C, D, X, and Y. In this example, the user has designated device X as a talker node S64 and device Y as a listener node S2. The user has also drawn or dropped in links that represent cables connecting devices X-A-C-Y, devices X-B-D-Y, and devices X-B-C-Y.

Upon being commanded by the user (e.g., by clicking button 212 (findPubSub) in the control panel 200), the network topology manager 130 identifies redundant paths in the network and calculates timing for the paths. Specifically, the topology manager 130 automatically identifies the talker node S64, the listener node S2, each device A, B, C, D, X, and Y, and each available path between S64 and S2 through these devices. The topology manager 130 then calculates the minimum transit time (e.g., ingressCost+residenceCost+egressCost) for each device, as well as the latency for each available path between S64 and S2 (e.g., sum of minimum transit time for all devices in path). It will be appreciated that the above is not necessarily a sequential, step-by-step, operation. Rather, the topology manager 130 is configured to simultaneously calculate timing and determine which path to explore further, as well as decide when to stop looking for paths. Once the unique paths are found, the topology manager 130 eliminates any temporary paths, thus leaving only the unique paths.

In this example, the topology manager 130 has identified two redundant paths. The first path starts at node S64 and goes through devices X-B-D-Y to end on node S1, as indicated by reference numbers 1402, 1404, 1406, 1408 and 1410. The second path starts at node S64 and goes through devices X-A-C-Y to end on node S1, as indicated by reference numbers 1412, 1414, 1416, 1418 and 1420. The network topology manager 130 depicts these paths using the same color as the color of node S2, namely, purple, for tracking purposes. And because the paths were found to satisfy timing requirements, the topology manager 130 uses a solid purple line to depict these paths. In addition, the topology manager 130 includes basic information about each path the lines representing the path. Thus, for example, the path information “S64→2 3BD” on solid purple line 1402 indicates the message originates from node S64, has message priority 2, there are 3 hops remaining at that point, and the message goes through devices B and D. The path information “S64→2 2BD” on the second solid purple line 1404 indicates the same information as above, except there are now 2 hops remaining, and so forth.

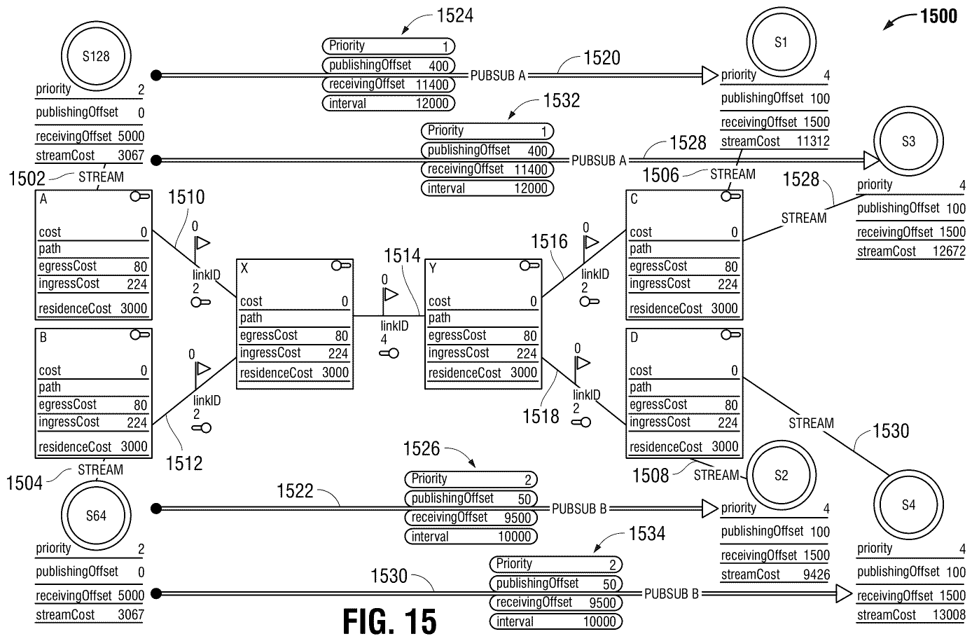

FIG. 15 shows an exemplary user interface 1500 for the network topology manager 130 in which the user has created a network that includes an additional stream for each of the two talkers, S128 and S64. The network in FIG. 15 is similar to the network in FIG. 7 insofar as the user has defined two streams for the network using two talkers, S128 and S64, two listeners S1 and S2, and six devices A, B, C, D, X, and Y arranged as shown. The user does this by dragging and dropping nodes S128 & S64 and S1 & S2 onto their respective devices A & B and C & D, which automatically creates a link between the nodes and the devices, indicated at lines 1502 & 1504 (“STREAM”) and 1506 & 1508 (“STREAM”), respectively. The user has also drawn a line (or dropped a link) between the six devices A, B, C, D, X, and Y, to create a link between the devices, as indicated at 1510, 1512, 1514, 1516, and 1518.

The user then drew a line (or dropped a link) between S128 and S1, and the network topology manager 130 automatically created a first stream “PUBSUB A” between the two nodes using a double blue lines 1520. In the same fashion, the user has also created a first stream “PUBSUB B” between S64 and S2, as indicated by double blue lines 1522. Each stream 1520 and 1522 automatically incorporates the priority and timing parameters of their respective devices and applications, which may be displayed in a set of communication labels 1524 and 1526 adjacent to the streams.

In the present example, the user has created two additional streams, one for each of the two nodes, S128 and S64. Specifically, the user has added nodes S3 & S4 to the network by dragging and dropping each node onto its respective device C & D, which automatically creates a link between the nodes and the devices, indicated at lines 1528 & 1530 (“STREAM”). The user thereafter drew a line (or dropped a link) between S128 and S3, and the network topology manager 130 automatically created a second stream “PUBSUB A” between the two nodes using a double blue lines 1520. In the same manner, the user has also created a second stream “PUBSUB B” between S64 and S4, as indicated by double blue lines 1530. Each new stream 1528 and 1530 automatically incorporates the priority and timing parameters of their respective devices and applications, which may be displayed in a set of communication labels 1532 and 1534 adjacent to the streams.

Once the user has constructed the network as depicted in FIG. 15, the user can click button 210 (findPubSub) or button 212 (findPubSub) in the control panel 200 (FIG. 2) to automatically calculate message timing for the various links and streams.

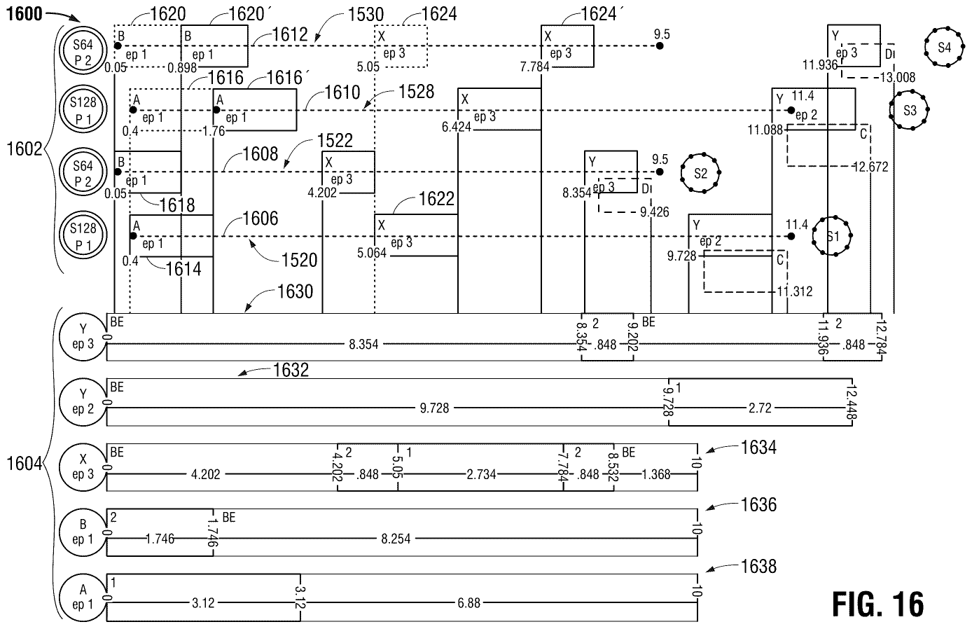

FIG. 16 shows an exemplary overlay view 1600 of the network topology manager 130 that depicts the message timing of the network in FIG. 15 in a combined communication timing diagram (CTD) and TAS gate view (TGV). In this example, the network topology manager 130 has depicted the four streams 1520, 1522, 1528, and 1530 from FIG. 15 as latency lines 1606, 1608, 1610, and 1612, respectively, in the top half of the overlay view 1600, generally indicated at 1602. The message frames for each stream 1520, 1522, 1528, and 1530 are depicted as rectangular blocks on the respective latency lines 1606, 1608, 1610, and 1612. Each rectangular blocks (e.g., blocks 1614, 1616, 1618, 1620, and 1622) represent the time that a frame spends “on the wire” and have a length that is proportional to the size of that frame (in bytes). Each block is also marked with a corresponding device designation and egress port number (e.g., “A ep1” in block 1614 means device A and egress port 1).

In the bottom half of the overlay view 1600, generally indicated at 1604, the network topology manager 130 depicts timing graphs for devices A, B, X, and Y from the network of FIG. 15. These devices may be selected by the user or automatically selected by the network topology manager 130 based on which devices were involved in message frame transmission. In either case, for each device and each egress port thereof, the network topology manager 130 displays a time graph that again may resemble a Gantt chart in appearance. Thus, there is a time graph 1630, 1632, 1634, 1636, and 1638, respectively, for each of device Y and egress ports 3 and 2, device X and egress port 3, device B and egress port 1, and device A and egress port 1. Each time graph includes one or more rectangular blocks, the size of which is proportional to the amount of time that a device spends transmitting a message frame through the particular port.

From the overlay view 1600, the user can quickly make several observations. First, as the upper half 1602 shows, the S128 message frame transmitted by device A at times 0.4 for stream 1520, as indicated by block 1614, interferes with the S128 message frame that was supposed to be transmitted by device A at times 0.4 for stream 1528, as indicated by block 1616. Device A must therefore delay transmission of the S128 message frame for stream 1528 until time 1.76, as indicated by block ′1616, which results in a timing violation for stream 1528. Similarly, the S64 message frame transmitted by device B at times 0.05 for stream 1522, as indicated by block 1618, interferes with the S64 message frame that was supposed to be transmitted by device B at times 0.05 for stream 1530, as indicated by block 1620. Device B must therefore delay transmission of the S64 message frame for stream 1530 until time 0.898, as indicated by block ′1620. Likewise, the S128 message frame transmitted by device X at time 5.064 for stream 1520, as indicated by block 1622, interferes with the S64 message frame that was supposed to be transmitted by device X at time 5.05 for stream 1530, as indicated by block 1624. That frame must be delayed until time 7.784, as indicated by block ′1624, which results in a timing violation on stream 1530. Accordingly, the network topology manager 130 depicts the blocks 1616, 1620, and 1624 that needed to be delayed as “ghost” blocks, and the latency lines 1610 and 1612 for streams 1520 and 1530, respectively, in a red color.

Second, as can be seen in the lower half 1604 of the overlay view 1600, some of the devices are required to hold open gates for an extended time. For example, device X has to hold open a priority 1 gate on egress port 3 for 2.743 time units to accommodate a message frame on stream 1520 and another message frame on stream 1528. This corresponds to high usage of bandwidth for device X. A similar high bandwidth usage can be seen at device A having to hold open a priority 1 gate on egress port 1.

To remedy the above timing violations on streams 1528 and 1530, the user can configure the network topology manager 130 to change the communication mode of the talker nodes in the network from the current unicast communication mode (i.e., one-to-one communication) to a multicast communication mode (i.e., one-to-many communication).

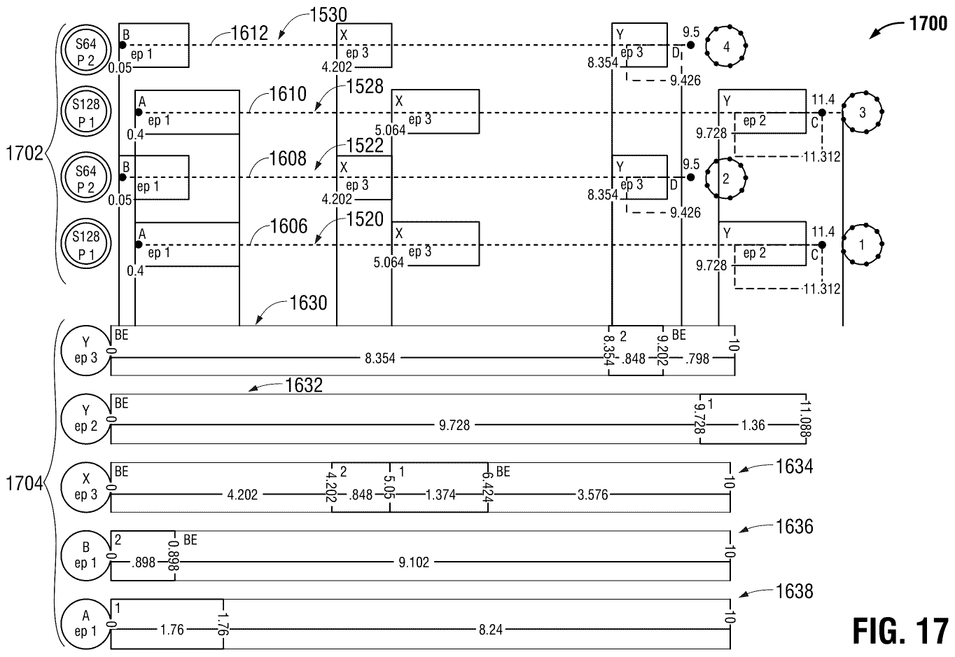

FIG. 17 shows an exemplary overlay view 1700 of the network topology manager 130 with the talker nodes operating in multicast communication mode. The overlay view 1700 is similar to the overlay view 1600 from FIG. 16 insofar both views combine communication timing diagram (CTD) and TAS gate view (TGV). Thus, the top half of the overlay view, indicated generally at 1702, shows the same latency lines 1606, 1608, 1610, and 1612 corresponding to the same streams 1520, 1522, 1528, and 1530, respectively, while the bottom half of the overlay view, generally indicated at 1704, shows timing graphs for devices A, B, X, and Y from the network of FIG. 15. As can be seen in the top half 1702, the latency lines 1606, 1608, 1610, and 1612 are now depicted using a green color indicating that the previous timing violations have been corrected by virtue of putting the talker nodes into multicast mode. And as can be seen in the bottom half 1704, the gates of the various devices are held open for a shorter duration that uses less bandwidth compared to when the talker nodes were operating in unicast mode. In particular, there are now no gates that span more than the size of a single frame.

Thus far, embodiments of the present disclosure have been described with respect to streams that shared the same communication interval. However, embodiments of the network topology manager 130 are equally capable of performing and displaying timing calculations for streams with different communication intervals. An example of the topology manager 130 operating on streams with multiple communication intervals is discussed below.

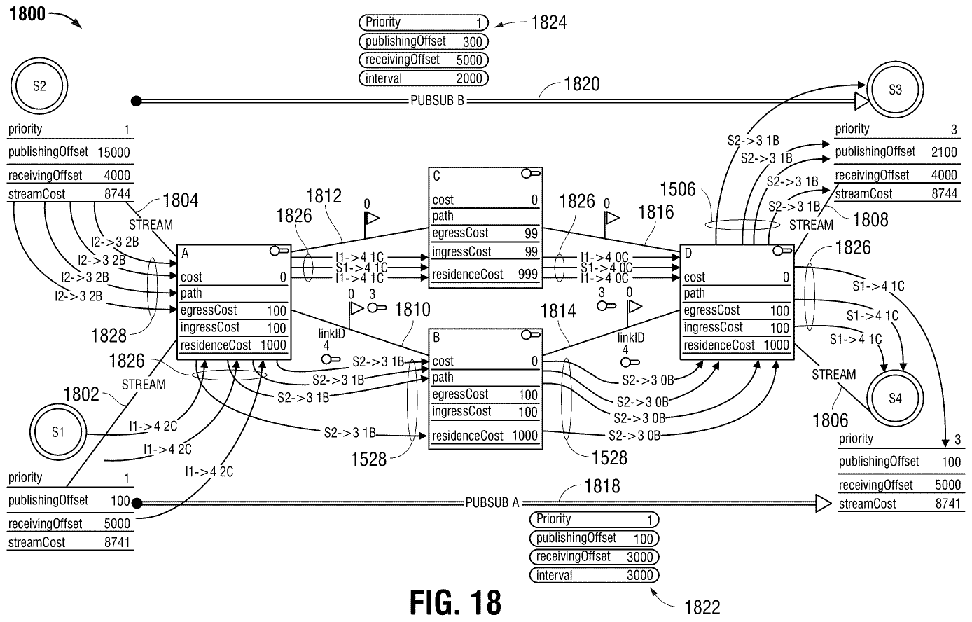

FIG. 18 shows an exemplary user interface 1800 for the network topology manager 130 in which the user has created a network that includes talkers having more than one communication interval. The multi-interval network in FIG. 18 is similar to the previous networks insofar as the user has defined two streams for the network using two talkers, S1 and S2, two listeners S3 and S4, and four devices A, B, C, and D, arranged as shown. The user does this by dragging and dropping talker nodes S1 & S2 onto device A and listener nodes S3 & S4 onto device D, which automatically creates a link between the nodes and the devices, as indicated at lines 1802 & 1804 (“STREAM”) and 1806 & 1808 (“STREAM”), respectively. The user has also drawn a line (or dropped a link) between the four devices A, B, C, and D, to create a link between the devices, as indicated at 1810, 1812, 1814, and 1816.

The user then drew a line (or dropped a link) between nodes S1 and S4, and the network topology manager 130 automatically created a stream “PUBSUB A” between the two nodes using a double blue lines 1818. In the same fashion, the user has also created a stream “PUBSUB B” between nodes S2 and S3, as indicated by double blue lines 1820. Each stream 1818 and 1820 automatically incorporates the priority and timing parameters of their respective devices and applications, which may be displayed in a set of communication labels 1822 and 1824 adjacent to each stream. As these labels show, stream PUBSUB A between nodes S1 and S4 has a communication interval of 3000 time units, while stream PUBSUB B between nodes S2 and S3 has a communication interval of 2000 time units.

Once the user has created or otherwise established the network shown in FIG. 18, the topology manager 130 may be instructed to find all paths in the network and calculate all message timing for the network (e.g., by clicking button 210 (CNC-findAllPaths) or button 212 (findPubSub) in the control panel 200). In some embodiments, the network topology manager 130 calculates message timing for the network by finding a Largest Common Multiplier (LCM) for the different communication intervals to determine how many overlapping timing iterations exist between the intervals. The topology manager 130 then performs message timing calculation for each iteration of each stream to determine the timing for each iteration.

In the present example, the Largest Common Multiplier (LCM) for 3000 time units (stream PUBSUB A) and 2000 time units (stream PUBSUB B) is 6000 time units (i.e., 3000×2 and 2000×3). Therefore, the topology manager 130 calculates timing for 2 additional iterations of stream PUBSUB A, and 3 additional stream iterations of stream PUBSUB B. Thus, in this example, the topology manager 130 calculates timing for a total of 3 iterations of stream PUBSUB A, including the initial iteration plus the 2 additional iterations, and a total of 4 iterations of stream PUBSUB B, including the initial iteration plus the 3 additional iterations.

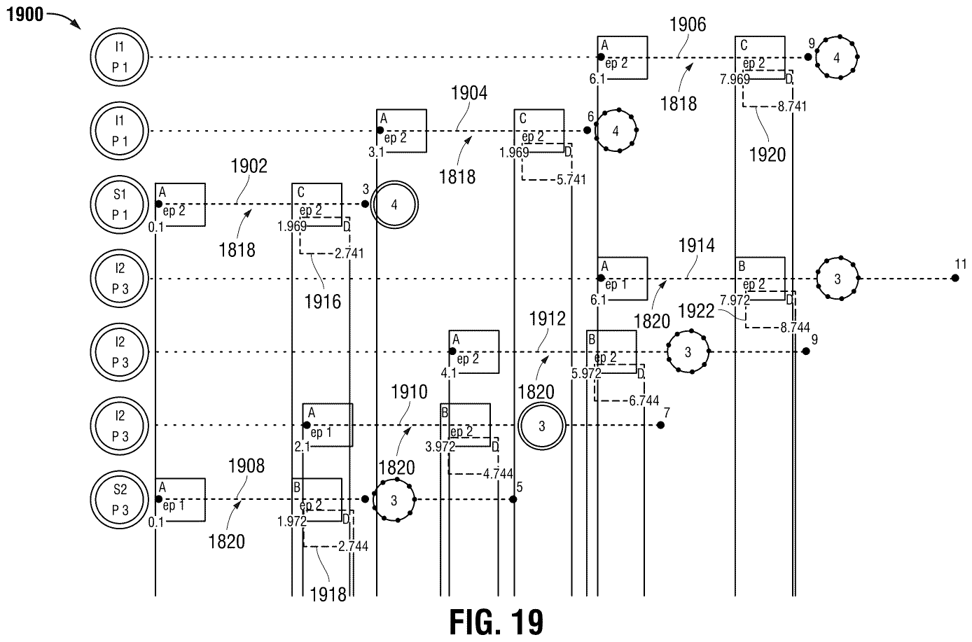

The resulting paths from the 3 iterations for stream PUBSUB A are encircled at 1826 in FIG. 18. The network topology manager 130 depicted these paths 1826 using yellow lines corresponding to the yellow color of node S4, with a solid arrow on the end of the line representing the initial iteration that established the path of the interval, and hollow arrows on the ends of the lines for the successive iterations that follow the initial path. Similarly, the paths resulting from the 4 iterations for PUBSUB B are encircled at 1828. The network topology manager 130 depicted these paths 1828 using purple lines corresponding to the purple color of node S3, again with a solid arrow on the end of the line representing the initial iteration that established the path of the interval, and hollow arrows for the successive iterations that follow the initial path. Each line carries basic information about the path represented by that line. For example, the path information “S1→4 2C” on the initial path from S1 indicates the message originates from node S1, is destined for node S4, there are 2 hops remaining at that point, and the path goes through device C. Similarly, the path information “I1→4 2C” on one of the iteration paths from S1 indicates that the path is an iteration, is destined for node S4, there are 2 hops remaining at that point, and the path goes through device C. It will be appreciated that the foregoing path information scheme is for illustrative purposes only, and alternatives and modifications are within the scope of the disclosed embodiments. Note that all the paths 1826 and 1830 are depicted using solid yellow lines and solid purple lines, respectively, indicating all iterations have acceptable message timing. However, more details can be seen in FIG. 19.

FIG. 19 shows an exemplary communication timing diagram (CTD) 1900 that the network topology manager 130 generated for the multi-interval network of FIG. 18. For stream PUBSUB A (1818), the topology manager 130 used latency lines 1902, 1904, and 1906 to depict the 3 iterations corresponding to that stream, and for stream PUBSUB B (1820), the topology manager 130 used latency lines 1908, 1910, 1912, and 1914 to depict the 4 iterations corresponding to that stream. Rectangular blocks on each latency line represent the time that a frame spends “on the wire” for the stream iteration corresponding to that line. In this example, all latency lines have been depicted using a green color, indicating acceptable message timing for all stream iterations. However, it can be readily seen on latency line 1902 that the arrival of the S1 frame at device D, as indicated by block 1916, interferes with the arrival of the S2 frame at device D, as indicated by block 1918 on latency line 1908. Similarly, the arrival of the I1 frame at device D, as indicated by block 1920 on latency line 1906, interferes with the arrival of the I2 frame at device D, as indicated by block 1922 on latency line 1914. Such a view allows the user to easily see potential problems and take appropriate action if needed.

Thus far, several exemplary embodiments of the network topology manager have been described herein. Following now is a method that may be used by or with embodiments of the network topology manager.

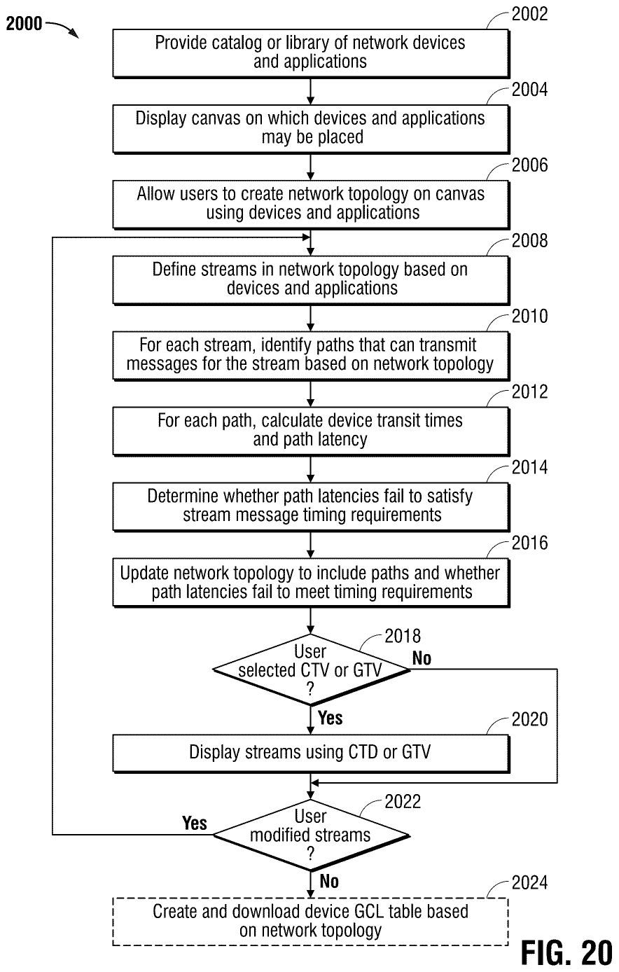

FIG. 20 shows a flowchart representing a method 2000 that may be used by or with embodiments of the network topology manager to construct TSN-based networks and automatically determine whether TSN timing requirements are satisfied. The method generally begins at block 2002 where the topology manager provides users with one or more catalogs or libraries of network devices and applications. The catalogs or libraries may operate in either offline mode, online mode, or both, depending on availability of data for the devices and applications. Examples of devices may include source devices infrastructure devices destination devices, and the like in some embodiments. Examples of applications may include nodes, links, streams, and the like in some embodiments. At block 2004, the topology manager displays a canvas or other graphical medium on which the devices and applications may be placed. At block 2006, the topology manager allows a user to create a network topology on the canvas using the devices and applications from the catalogs or libraries. For example, the user may drag-and-drop a device or application onto the canvas, or the user may right-click on the campus to access the catalogs or libraries.

At 2008, the topology manager defines one or more streams in the network topology, including all message timing requirements therefor, based on the devices and applications the user placed on the canvas. These message timing requirements may include, for example message priority, publishing offset, receiving offset, communication interval, and the like. At block 2010, for each stream, the topology manager identifies one or more, or all, paths in the network topology that are available to transmit a message for the stream based on the devices and applications. This may be accomplished, for example, by identifying the talker and listener nodes in the stream and identifying which devices can be used to transmit a message frame from the talker node to the listener node. In some embodiments, a talker node may transmit message frames to more than one listener node.

At block 2012, for each path, the topology manager calculates minimum transit times for each device in the path as well as the latency of the path. This may involve adding up the ingress cost in time, residence cost in time, and egress cost in time for each device in the path, and totaling all such costs incurred in the path. At block 2014, the topology manager determines whether the path latencies for the various paths satisfy stream message timing requirements. At block 2016, the topology manager updates the network topology to include and display the various paths and an indication of whether their path latencies satisfy stream message timing requirements. In some embodiments, paths with latencies that satisfy the stream message timing requirements may be displayed using a different color (e.g., green, red, etc.) and/or a different line type (e.g., solid line, dashed line, etc.) from paths with latencies that do not satisfy stream message timing requirements.

At block 2018, the topology manager makes a determination whether the user has selected a communication timing diagram (CTD), or a gate timing view (GTV), or some other view. If the user has selected any of those viewing options, then at block 2020, the topology manager displays the streams using the selected viewing option. For the CTD option, the display may include a graphical representation of various nodes in a stream, latency lines for devices in the stream, and message frame size for devices in the stream. For the GTV option, the display may include a graphical representation of various nodes in a stream, a time graph for devices in the stream, and gate times for devices in the stream. In some embodiments, the topology manager may displays either the CDT view or the GTV be default, such that one or the other views is always present and populated with new data each time calculations are performed, unless the user selects otherwise.

At block 2022, the topology manager makes a determination whether the user has modified any stream. This may include modifications to the number and arrangement of devices and applications in the network topology, adjustments to the latency lines and message transmission times for devices in the stream, as well as adjustments to the gate times for devices in the stream. If the determination is yes, then the topology manager returns to block 2008 to repeat the previous stream and device identifications and path latency calculations. If the determination is no, then at block 2024, in some embodiments, the topology manager may optionally creates a device GCL table based on the network topology and/or downloads or otherwise exports the device GCL table to any real-world devices currently present in the network. This allows the topology manager to automatically update any real-world devices currently present in the network with the most recent device configurations based on the network topology and modifications thereto.

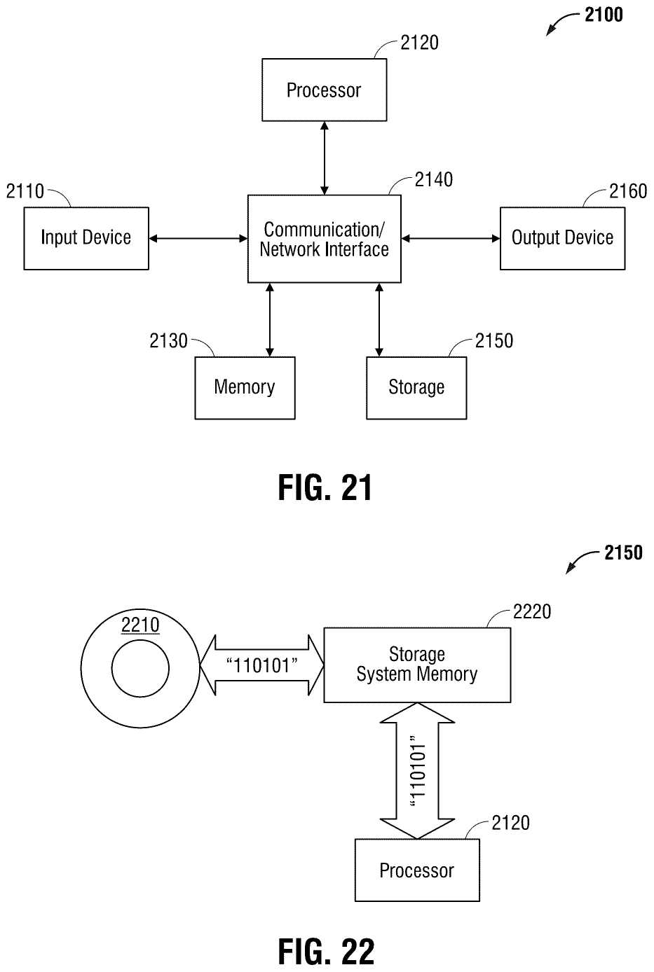

FIG. 21 illustrates an exemplary system 2100 that may be used to implement various embodiments of the network topology manager discussed in this disclosure. For example, various embodiments of the disclosure may be implemented as specialized software executing in a system 2100 such as that shown in FIG. 21. The system 2100 may include a processor 2120 connected to one or more memory devices 2130, such as magnetic or solid sate memory, either embedded and discrete, or other memory devices for storing data. Memory 2130 is typically used for storing programs and data during operation of the system 2100. The system 2100 may also include a storage system 2150 that provides additional storage capacity. Components of system 2100 may be coupled by a communication interface 2160, which may include one or more busses (e.g., between components that are integrated within the same machine) and/or a network interface 2160 (e.g., between components that reside on separate discrete machines). The communication/network interface 2160 enables communications (e.g., data, instructions) to be exchanged between system components of system 2100 and system components of other systems on the network.

System 2100 also includes one or more input devices 2110, for example, keys, buttons, microphone, touch screen, and one or more output devices 2180, for example, a display screen, LEDs, and the like. In addition, system 2100 may contain one or more interfaces (not shown) that connect system 2100 to a communication network (in addition or as an alternative to the interconnection mechanism 2160).

The storage system 2150, shown in greater detail in FIG. 22, typically includes a computer readable and writeable nonvolatile recording medium 2210 in which signals are stored that define a program to be executed by the processor 2120 or information stored on or in the medium 2210 to be processed by the program to perform one or more functions associated with embodiments described herein. To this end, the processor 2120 may be any suitable processing unit, such as a microprocessor, microcontroller, ASIC, and the like, and the medium any suitable recording medium, such as a magnetic or solid-state memory. Typically, in operation, the processor 2120 causes data to be read from the nonvolatile recording medium 2210 into storage system memory 2260 that allows for faster access to the information by the processor than does the medium 2210. This storage system memory 2260 is typically a volatile, random access memory such as a dynamic random-access memory (DRAM) or static memory (SRAM). This storage system memory 2260 may be located in storage system 2150, as shown, or in the system memory 2130. The processor 2120 generally manipulates the data within the memory system 2260 and then copies the data to the medium 2210 after processing is completed. A variety of mechanisms are known for managing data movement between the medium 2210 and the integrated circuit memory element 2260, and the disclosure is not limited thereto. The disclosure is not limited to a particular memory 2260, memory 2130 or storage system 2150.

The system 2100 may include specially programmed, special-purpose hardware, for example, an application-specific integrated circuit (ASIC). Aspects of the disclosure may be implemented in software, hardware or firmware, or any combination thereof. Further, such methods, acts, systems, system elements and components thereof may be implemented as part of the system described above or as an independent component.

Although the system 2100 is shown by way of example as one type of system upon which various aspects of the disclosure may be practiced, it should be appreciated that aspects of the disclosure are not limited to being implemented on the system as shown in FIG. 21. Various aspects of the disclosure may be practiced on one or more devices having a different architecture or components from that shown in FIG. 21. Further, where functions or processes of embodiments of the disclosure are described herein (or in the claims) as being performed on a processor or controller, such description is intended to include systems that use more than one processor or controller to perform the functions.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

It will be appreciated that the development of an actual commercial application incorporating aspects of the disclosed embodiments will require many implementation-specific decisions to achieve a commercial embodiment. Such implementation specific decisions may include, and likely are not limited to, compliance with system related, business related, government related and other constraints, which may vary by specific implementation, location and from time to time. While a developer's efforts might be considered complex and time consuming, such efforts would nevertheless be a routine undertaking for those of skill in this art having the benefit of this disclosure.

It should also be understood that the embodiments disclosed and taught herein are susceptible to numerous and various modifications and alternative forms. Thus, the use of a singular term, such as, but not limited to, “a” and the like, is not intended as limiting of the number of items. Similarly, any relational terms, such as, but not limited to, “top,” “bottom,” “left,” “right,” “upper,” “lower,” “down,” “up,” “side,” and the like, used in the written description are for clarity in specific reference to the drawings and are not intended to limit the scope of the invention.

This disclosure is not limited in its application to the details of construction and the arrangement of components set forth in the following descriptions or illustrated by the drawings. The disclosure is capable of other embodiments and of being practiced or of being carried out in various ways. Also, the phraseology and terminology used herein is for the purpose of descriptions and should not be regarded as limiting. The use of “including,” “comprising,” “having,” “containing,” “involving,” and variations herein, are meant to be open-ended, i.e., “including but not limited to.”

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or system, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage system, a magnetic storage system, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

One or more portions of the computer system may be distributed across one or more computer systems coupled to a communications network. For example, as discussed above, a computer system that determines available power capacity may be located remotely from a system manager. These computer systems also may be general-purpose computer systems. For example, various aspects of the disclosure may be distributed among one or more computer systems configured to provide a service (e.g., servers) to one or more client computers, or to perform an overall task as part of a distributed system. For example, various aspects of the disclosure may be performed on a client-server or multi-tier system that includes components distributed among one or more server systems that perform various functions according to various embodiments of the disclosure. These components may be executable, intermediate (e.g., IL) or interpreted (e.g., Java) code which communicate over a communication network (e.g., the Internet) using a communication protocol (e.g., TCP/IP). For example, one or more database servers may be used to store system data, such as expected power draw, that is used in designing layouts associated with embodiments of the present disclosure.

It should be appreciated that the disclosure is not limited to executing on any particular system or group of systems. Also, it should be appreciated that the disclosure is not limited to any particular distributed architecture, network, or communication protocol.

Various embodiments of the present disclosure may be programmed using an object-oriented programming language, such as SmallTalk, Java, C++, Ada, or C#(C-Sharp). Other object-oriented programming languages may also be used. Alternatively, functional, scripting, and/or logical programming languages may be used, such as BASIC, Fortran, Cobol, TCL, or Lua. Various aspects of the disclosure may be implemented in a non-programmed environment (e.g., analytics platforms, or documents created in HTML, XML or other format that, when viewed in a window of a browser program render aspects of a graphical-user interface (GUI) or perform other functions). Various aspects of the disclosure may be implemented as programmed or non-programmed elements, or any combination thereof.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus far, a number of features and advantages of embodiments of the present disclosure have been shown and described. Other possible features and advantages associated with the disclosed embodiments will be appreciated by one of ordinary skill in the art. It should also be understood that embodiments of the disclosure herein may be configured as a system, method, or combination thereof. Accordingly, embodiments of the present disclosure may be comprised of various means including hardware, software, firmware or any combination thereof.

It is to be appreciated that the concepts, systems, circuits and techniques sought to be protected herein are not limited to use in the example applications described herein (e.g., industrial applications), but rather may be useful in substantially any application where it is desired to monitor, whether visually or remotely, the status/configuration of a system or equipment. While particular embodiments and applications of the present disclosure have been illustrated and described, it is to be understood that embodiments of the disclosure not limited to the precise construction and compositions disclosed herein and that various modifications, changes, and variations can be apparent from the foregoing descriptions without departing from the spirit and scope of the disclosure as defined in the appended claims.

Having described preferred embodiments, which serve to illustrate various concepts, structures and techniques that are the subject of this patent, it will now become apparent to those of ordinary skill in the art that other embodiments incorporating these concepts, structures and techniques may be used. Additionally, elements of different embodiments described herein may be combined to form other embodiments not specifically set forth above. Accordingly, it is submitted that that scope of the patent should not be limited to the described embodiments but rather should be limited only by the spirit and scope of the following claims.

What is claimed is:

1. A system for managing TSN-based network topologies, the system comprising:
a processor;
a display unit communicatively coupled to the processor and configured to be controlled by the processor;
a storage unit communicatively coupled to the processor, the storage unit storing processor-executable instructions thereon for a network topology manager, the network topology manager, when executed by the processor, causes the system to:
display on the display unit a canvas on which network devices and network applications may be graphically placed;
allow a user to graphically create a network topology on the canvas using the network devices and the network applications;
define one or more streams in the network topology based on the network devices and the network applications, each stream including a talker node and a listener node and one or more message timing requirements for a message from the talker node to the listener node;
identify, for at least one stream, a path in the stream that is capable of transmitting a message for the stream;
calculate a path latency for the path, the path latency indicating a time required to transmit a message from the talker node to the listener node along the path;
determine whether the path latency for the path fails to satisfy the one or more message timing requirements for the message from the talker node to the listener node; and
update the network topology on the canvas to include the path and an indication of whether the path latency for the path fails to satisfy the one or more message timing requirements.

2. The system of claim 1, wherein the network topology manager further causes the system to provide at least one library configured to store network the network devices and the network applications therein.

3. The system of claim 1, wherein the network topology manager further causes the system to identify a redundant path for the at least one stream and to calculate a path latency for the redundant path.

4. The system of claim 3, wherein the network topology manager further causes the system to determine a lowest path latency for the at least one stream based on the path latency of the path and the path latency of the redundant path.

5. The system of claim 1, wherein the network topology manager further causes the system to display the path on the canvas using a preselected color and/or a preselected line type if the path latency for the path fails to satisfy the one or more message timing requirements.

6. The system of claim 1, wherein the network topology manager further causes the system to display the network topology on the canvas using a communication timing diagram (CTD), the CTD including a latency line for each stream in the network topology, each latency line having one or more blocks thereon, each block being proportional to a size of a message frame transmitted for the stream.

7. The system of claim 6, wherein the network topology manager further causes the system to allow the user to graphically adjust a length of the latency line for each stream using a sliding motion, and to graphically adjust a position of the one or more blocks on the latency line using a sliding motion.

8. The system of claim 1, wherein the network topology manager further causes the system to display the network topology on the canvas using a gate timing view (GTV), the GTV including a time graph for each stream in the network topology, each time graph having one or more blocks thereon, each block being proportional to an amount of time that a given device spends transmitting a message frame for the stream.

9. The system of claim 1, wherein the network topology manager further causes the system to display the path on the canvas using a preselected color and/or a preselected line type if the path latency for the path fails to satisfy the one or more message timing requirements.

10. The system of claim 1, wherein the one or more message timing requirement includes a communication interval and at least two streams in the network topology have different communication intervals from one another.

11. A method for managing TSN-based network topologies, the method comprising:
performing, by a processor, a process that displays on a display unit a canvas on which network devices and network applications may be graphically placed;
performing, by the processor, a process that allows a user to graphically create a network topology on the canvas using the network devices and the network applications;
performing, by the processor, a process that defines one or more streams in the network topology based on the network devices and the network applications, each stream including a talker node and a listener node and one or more message timing requirements for a message from the talker node to the listener node;
performing, by the processor, a process that identifies, for at least one stream, a path in the stream that is capable of transmitting a message for the stream;
performing, by the processor, a process that calculates a path latency for the path, the path latency indicating a time required to transmit a message from the talker node to the listener node along the path;
performing, by the processor, a process that determines whether the path latency for the path fails to satisfy the one or more message timing requirements for the message from the talker node to the listener node; and
performing, by the processor, a process that updates the network topology on the canvas to include the path and an indication of whether the path latency for the path fails to satisfy the one or more message timing requirements.

12. The method of claim 11, further comprising performing, by the processor, a process that provides at least one library configured to store network the network devices and the network applications therein.

13. The method of claim 11, further comprising performing, by the processor, a process that identifies a redundant path for the at least one stream and to calculate a path latency for the redundant path.

14. The method of claim 13, further comprising performing, by the processor, a process that determines a lowest path latency for the at least one stream based on the path latency of the path and the path latency of the redundant path.

15. The method of claim 11, further comprising performing, by the processor, a process that displays the path on the canvas using a preselected color and/or a preselected line type if the path latency for the path fails to satisfy the one or more message timing requirements.

16. The method of claim 11, further comprising performing, by the processor, a process that displays the network topology on the canvas using a communication timing diagram (CTD), the CTD including a latency line for each stream in the network topology, each latency line having one or more blocks thereon, each block being proportional to a size of a message frame transmitted for the stream.

17. The method of claim 16, further comprising performing, by the processor, a process that allows the user to graphically adjust a length of the latency line for each stream using a sliding motion, and to graphically adjust a position of the one or more blocks on the latency line using a sliding motion.

18. The method of claim 11, further comprising performing, by the processor, a process that display the network topology on the canvas using a gate timing view (GTV), the GTV including a time graph for each stream in the network topology, each time graph having one or more blocks thereon, each block being proportional to an amount of time that a given device spends transmitting a message frame for the stream.

19. The method of claim 11, further comprising performing, by the processor, a process that display the path on the canvas using a preselected color and/or a preselected line type if the path latency for the path fails to satisfy the one or more message timing requirements.

20. The method of claim 11, wherein the one or more message timing requirement includes a communication interval and at least two streams in the network topology have different communication intervals from one another.

21. A non-transitory computer-readable medium configured to store computer-readable instructions thereon, the computer-readable instructions, when executed by a processor, causes the processor to.
perform a process that displays on a display unit a canvas on which network devices and network applications may be graphically placed;
perform a process that allows a user to graphically create a network topology on the canvas using the network devices and the network applications;
perform a process that defines one or more streams in the network topology based on the network devices and the network applications, each stream including a talker node and a listener node and one or more message timing requirements for a message from the talker node to the listener node;
perform a process that identifies, for at least one stream, a path in the stream that is capable of transmitting a message for the stream;
perform a process that calculates a path latency for the path, the path latency indicating a time required to transmit a message from the talker node to the listener node along the path;
perform a process that determines whether the path latency for the path fails to satisfy the one or more message timing requirements for the message from the talker node to the listener node; and
perform a process that updates the network topology on the canvas to include the path and an indication of whether the path latency for the path fails to satisfy the one or more message timing requirements.
